(19) United States
(12) Patent Application Publication
(10) Pub. No.: US 2024/0101904 A1
(43) Pub. Date: Mar. 28, 2024

(54) LIQUID CRYSTAL POLYESTER POWDER, COMPOSITION, METHOD FOR PRODUCING COMPOSITION, METHOD FOR PRODUCING FILM, AND METHOD FOR PRODUCING LAMINATED BODY

(71) Applicant: SUMITOMO CHEMICAL COMPANY, LIMITED, Tokyo (JP)

(72) Inventors: Shohei AZAMI, Ibaraki (JP); Toyonari ITO, Tokyo (JP)

(21) Appl. No.: 18/263,026

(22) PCT Filed: Feb. 2, 2022
(86) PCT No.: PCT/JP2022/003999

§ 371 Date: Jul. 26, 2023

(30) Foreign Application Priority Data
Feb. 2, 2021 (JP) 2021-015002

(51) Int. Cl. C09K 19/38; C09K 19/32

(52) U.S. Cl. CPC C09K 19/3809; C09K 19/322; C09K 2219/03

(57) ABSTRACT

The present invention relates to a liquid crystal polyester powder comprising a liquid crystal polyester, wherein, when a particle diameter at which a cumulative volume proportion from a small particle side in a volume-based cumulative particle diameter distribution curve by laser diffraction/scattering type particle diameter distribution measurement is 90% is defined as D₉₀, D₉₀ is 20 μm or less.

### TECHNICAL FIELD

The present invention relates to a liquid crystal polyester powder, a composition, a method for producing the composition, a method for producing a film, and a method for producing a laminated body.

The present application claims priority based on Japanese Patent Application No. 2021-015002 filed in Japan on Feb. 2, 2021, the content of which is incorporated herein by reference in its entirety.

### BACKGROUND ART

An insulating material is used for a printed circuit substrate where an electronic part is mounted. In recent years, further improvement of physical properties such as dielectric properties of an insulating material has been demanded because of development of communication systems, and the like.

For example, Patent Literature 1 discloses an insulating resin composition comprising an epoxy resin containing a silyl group, a curing agent, and an inorganic filler such as silica, for the purpose of a reduction in dielectric loss.

### CITATION LIST

### Patent Literature

Patent Literature 1: Japanese Patent Laid-Open No. 2017-66360

### SUMMARY OF INVENTION

### Problems to be Solved by Invention

However, there have been made no sufficient studies about mechanical strength of a film obtained from the resin composition disclosed in Patent Literature 1.

In addition, high is possibility that a conventional substrate material is insufficient in dielectric properties at a high frequency, in consideration of application to the next-generation mobile communication system.

A liquid crystal polyester film has an excellent high frequency property and has a low water absorption property and thus attracts attention as an electronic substrate material.

An object of the present invention is to provide a liquid crystal polyester powder that can enhance mechanical strength of a liquid crystal polyester film produced using the liquid crystal polyester powder.

An object of the present invention is also to provide a liquid crystal polyester composition comprising a medium and the liquid crystal polyester powder, and a method for producing the liquid crystal polyester composition.

An object of the present invention is also to provide a method for producing a liquid crystal polyester film and a method for producing a laminated body, using the liquid crystal polyester composition.

### Means to Solve the Problems

The present inventors have carried out diligent studies in order to solve the above problem and as a result, have found that a liquid crystal polyester film having excellent mechanical strength is obtained by using a liquid crystal polyester powder having a D₉₀ in a particular range, and have completed the present invention.

That is, the present invention has the following aspects.

<1> A liquid crystal polyester powder comprising a liquid crystal polyester, wherein
when a particle diameter at which a cumulative volume proportion from a small particle side in a volume-based cumulative particle diameter distribution curve by laser diffraction/scattering type particle diameter distribution measurement is 90% is defined as D₉₀,
D₉₀ is 20 μm or less.

<2> The liquid crystal polyester powder according to the <1>, wherein a proportion of particles having a particle diameter of 30 μm or more, determined by laser diffraction/scattering type particle diameter distribution measurement, is 3% by volume or less based on a total volume of the liquid crystal polyester powder.

<3> The liquid crystal polyester powder according to the <1> or <2>, wherein a proportion of particles having a particle diameter of 20 μm or more, determined by laser diffraction/scattering type particle diameter distribution measurement, is 7% by volume or less based on a total volume of the liquid crystal polyester powder.

<4> The liquid crystal polyester powder according to any one of the <1> to <3>, wherein the liquid crystal polyester has a structural unit comprising a naphthalene structure.

<5> The liquid crystal polyester powder according to the <4>, wherein a content of the structural unit comprising a naphthalene structure in the liquid crystal polyester is 40 mol % or more based on 100 mol % of a total amount of all structural units in the liquid crystal polyester.

<6> The liquid crystal polyester powder according to any one of the <1> to <5>, wherein the liquid crystal polyester has a structural unit represented by the following formula (1), a structural unit represented by the following formula (2), and a structural unit represented by the following formula (3):

—O-Ar1-CO— (1)

—CO-Ar2-CO— (2)

—X-Ar3-Y— (3)
wherein Ar1 represents a phenylene group, a naphthylene group, or a biphenylylene group;
Ar2 and Ar3 each independently represent a phenylene group, a naphthylene group, a biphenylylene group, or a group represented by the following formula (4); X and Y each independently represent an oxygen atom or an imino group (—NH—); and
one or more hydrogen atoms in the group represented by Ar1, Ar2, or Ar3 are each independently optionally replaced with a halogen atom, an alkyl group having 1 to 10 carbon atoms, or an aryl group having 6 to 20 carbon atoms;

-Ar4-Z-Ar5- (4)
wherein Ar4 and Ar5 each independently represent a phenylene group or a naphthylene group; Z represents an oxygen atom, a sulfur atom, a carbonyl group, a sulfonyl group, or an alkylidene group having 1 to 10 carbon atoms; and
one or more hydrogen atoms in the group represented by Ar4 or Ar5 are each independently optionally replaced with a halogen atom, an alkyl group having 1 to 10 carbon atoms, or an aryl group having 6 to 20 carbon atoms.

<7> A liquid crystal polyester composition comprising a medium and the liquid crystal polyester powder according to any one of the <1> to <6>.

<8> The liquid crystal polyester composition according to the <7>, wherein the liquid crystal polyester powder is insoluble in the medium.

<9> The liquid crystal polyester composition according to the <7> or <8>, further comprising a resin soluble in the medium.

<10> The liquid crystal polyester composition according to the <9>, wherein the resin soluble in the medium is a liquid crystal polyester soluble in the medium.

<11> A method for producing the liquid crystal polyester composition according to any one of the <7> to <10>, the method comprising mixing a medium and the liquid crystal polyester powder according to any one of the <1> to <6>.

<12> A method for producing a liquid crystal polyester film, comprising: obtaining a liquid crystal polyester film comprising the liquid crystal polyester by applying the liquid crystal polyester composition according to any one of the <7> to <10> onto a support and heat-treating the liquid crystal polyester composition.

<13> A method for producing a laminated body, comprising: obtaining a laminated body comprising the support and the liquid crystal polyester film by applying the liquid crystal polyester composition according to any one of the <7> to <10> onto the support and heat-treating the liquid crystal polyester composition to form the liquid crystal polyester film comprising the liquid crystal polyester.

### Effects of Invention

According to the present invention, it is possible to provide a liquid crystal polyester powder that can enhance mechanical strength of a liquid crystal polyester film produced.

In addition, according to the present invention, it is possible to provide a liquid crystal polyester composition comprising a medium and the liquid crystal polyester powder, and a method for producing the liquid crystal polyester composition.

In addition, according to the present invention, it is possible to provide a method for producing a liquid crystal polyester film and a method for producing a laminated body, using the liquid crystal polyester composition.

### BRIEF DESCRIPTION OF DRAWINGS

FIG. 1A is a schematic diagram showing a production process of the liquid crystal polyester film and the laminated body according to one embodiment of the present invention.

FIG. 1B is a schematic diagram showing a production process of the liquid crystal polyester film and the laminated body according to one embodiment of the present invention.

FIG. 1C is a schematic diagram showing a production process of the liquid crystal polyester film and the laminated body according to one embodiment of the present invention.

FIG. 1D is a schematic diagram showing a production process of the liquid crystal polyester film and the laminated body according to one embodiment of the present invention.

FIG. 2 is a schematic diagram showing a configuration of the liquid crystal polyester film according to one embodiment of the present invention.

FIG. 3 is a schematic diagram showing a configuration of the laminated body according to one embodiment of the present invention.

### EMBODIMENTS FOR CARRYING OUT INVENTION

Hereinafter, embodiments of the liquid crystal polyester powder, composition, the method for producing the composition, the method for producing a film, and the method for producing a laminated body according to the present invention will be described.

<<Liquid Crystal Polyester Powder>>

The liquid crystal polyester powder of the embodiment is a liquid crystal polyester powder comprising a liquid crystal polyester, wherein, when the particle diameter at which the cumulative volume proportion from the small particle side in a volume-based cumulative particle diameter distribution curve by laser diffraction/scattering type particle diameter distribution measurement is 90% is defined as D₉₀, D₉₀ is 20 μm or less.

According to the liquid crystal polyester powder of the embodiment, it is possible to provide a liquid crystal polyester composition comprising a medium and the liquid crystal polyester powder.

According to the liquid crystal polyester composition, it is possible to enhance mechanical strength of a liquid crystal polyester film produced. The liquid crystal polyester composition is suitable as a raw material for a liquid crystal polyester film or a laminated body according to the embodiment. The details of the liquid crystal polyester film will be described later.

In the present description, the “mechanical strength” of the liquid crystal polyester film is evaluated by “tensile strength” and “tensile strength strain” obtained by measurement methods described later.

D₉₀ of the liquid crystal polyester powder is 20 μm or less, preferably 15 μm or less and more preferably 10 μm or less. Because D₉₀ of the liquid crystal polyester powder is equal to or less than the above upper limit value, it is possible to enhance mechanical strength of a liquid crystal polyester film produced from a composition comprising the liquid crystal polyester powder, as compared with a case where the requirement of D₉₀ of 20 μm or less is not satisfied.

The lower limit value of D₉₀ of the liquid crystal polyester powder is not particularly restricted, and is preferably 5 μm or more, more preferably 6 μm or more, and even more preferably 7 μm or more from the viewpoint of ease of handling the powder.

The above upper limit values and The above lower limit values of a value of D₉₀ of the above liquid crystal polyester powder can be freely combined. An example of the numerical range of a value of D₉₀ of the above liquid crystal polyester powder is preferably 5 μm or more and 20 μm or less, more preferably 6 μm or more and 15 μm or less, and even more preferably 7 μm or more and 10 μm or less.

When the particle diameter at which the cumulative volume proportion from the small particle side in a volume-based cumulative particle diameter distribution curve by laser diffraction/scattering type particle diameter distribution measurement is 50% is defined as D₅₀, the value of D₅₀ of the liquid crystal polyester powder of the embodiment is not particularly restricted as long as the above value of D₉₀ is satisfied. An example of the value of D₅₀ of the liquid crystal polyester powder may be 0.1 or more and 15 μm or less, 0.5 μm or more and 10 μm or less, or 0.5 μm or more and 7 μm or less.

The value of D₉₀—the value of D₅₀ (D₉₀−D₅₀) may be, for example, 10 μm or less, or may be 5 μm or less.

D₅₀ and D₉₀ of the liquid crystal polyester powder can be measured by the following method.

The liquid crystal polyester powder is dispersed in pure water to obtain a dispersion of the liquid crystal polyester powder, and a volume-based cumulative particle diameter distribution of the liquid crystal polyester powder is measured with the refractive index of pure water being 1.333 using a laser diffraction/scattering type particle diameter distribution measuring apparatus (for example, “LA-950V2” manufactured by HORIBA, Ltd.). The particle diameter (μm) at which the cumulative volume proportion from the small particle side is 50% is defined as D₅₀, and the particle diameter (μm) at which the cumulative volume proportion from the small particle side is 90% is defined as D₉₀.

In the liquid crystal polyester powder of the embodiment, the proportion of particles having a particle diameter of 30 μm or more, determined by the above laser diffraction/scattering type particle diameter distribution measurement, is preferably 3% by volume or less and more preferably 0% by volume based on the total volume of the liquid crystal polyester powder.

According to the liquid crystal polyester powder wherein the proportion of particles having a particle diameter of 30 μm or more is equal to or less than the above upper limit value, it is possible to enhance mechanical strength of a liquid crystal polyester film produced.

In the liquid crystal polyester powder of the embodiment, the proportion of particles having a particle diameter of 20 μm or more, determined by the above laser diffraction/scattering type particle diameter distribution measurement, is preferably 7% by volume or less, more preferably 5% by volume or less, even more preferably 2% by volume or less, and particularly preferably 0% by volume based on the total volume of the liquid crystal polyester powder.

According to the liquid crystal polyester powder wherein the proportion of particles having a particle diameter of 20 μm or more is equal to or less than the above upper limit value, it is possible to produce a liquid crystal polyester film having more favorable mechanical strength.

The proportion (% by volume) of a particle having a particle diameter of 20 μm or more or that of 30 μm or more in the liquid crystal polyester powder can be determined from a volume-based cumulative particle diameter distribution obtained by the above laser diffraction/scattering type particle diameter distribution measurement.

Although the reason why mechanical strength of a liquid crystal polyester film that can be produced is enhanced because of a small value of D₉₀ of the liquid crystal polyester powder and furthermore a low proportion of particles having a particle diameter of 20 μm or more or 30 μm or more is not clear, the following reason is presumed.

A liquid crystal polyester film can be produced by applying a liquid crystal polyester composition comprising the liquid crystal polyester powder, onto a support and heat-treating the liquid crystal polyester composition, as described below. The liquid crystal polyester composition may comprise, for example, other resin that does not correspond to the liquid crystal polyester powder. Probably, an individual liquid crystal polyester powder-derived portion remains in the obtained liquid crystal polyester film without being completely homogenized with an individual liquid crystal polyester powder or other resin portion. It is considered that bonding of interface portion on a surface of this liquid crystal polyester powder is easily weakened against tension of the film, and it is considered that the larger the particle size thereof is, the more remarkable this tendency is. It is presumed that, in the liquid crystal polyester powder of the present embodiment, tensile strength of the film is enhanced by reducing a proportion of a liquid crystal polyester powder having a large particle size.

The liquid crystal polyester powder of the embodiment comprises a liquid crystal polyester and may consist of a liquid crystal polyester.

The proportion of content of the liquid crystal polyester may be 50 to 100% by mass or 80 to 95% by mass based on 100% by mass of the liquid crystal polyester powder of the embodiment.

Hereinafter, the detail of the liquid crystal polyester included in the liquid crystal polyester powder of the embodiment will be described.

(Liquid Crystal Polyester)

The liquid crystal polyester according to the present embodiment is a polyester that exhibits a liquid crystal in a molten state and is preferably melted at a temperature of 450° C. or less. The liquid crystal polyester may be a liquid crystal polyester amide, a liquid crystal polyester ether, a liquid crystal polyester carbonate, or a liquid crystal polyester imide. The liquid crystal polyester is preferably a wholly aromatic liquid crystal polyester having only a structural unit derived from an aromatic compound as a raw material monomer.

In the present description, “derived” means that the chemical structure is changed for the polymerization of the raw material monomer, and no other changes of structure occur.

Typical examples of the liquid crystal polyester include a polymer obtained by condensation polymerization (polycondensation) of an aromatic hydroxycarboxylic acid, an aromatic dicarboxylic acid, and at least one compound selected from the group consisting of an aromatic diol, an aromatic hydroxyamine, and an aromatic diamine; a polymer obtained by polymerizing a plurality of aromatic hydroxycarboxylic acids; a polymer obtained by polymerizing an aromatic dicarboxylic acid and at least one compound selected from the group consisting of an aromatic diol, an aromatic hydroxylamine, and an aromatic diamine; and a polymer obtained by polymerizing a polyester such as polyethylene terephthalate and an aromatic hydroxycarboxylic acid.

Among these, a polymer obtained by condensation polymerization (polycondensation) of an aromatic hydroxycarboxylic acid, an aromatic dicarboxylic acid, and at least one compound selected from the group consisting of an aromatic diol, an aromatic hydroxyamine, and an aromatic diamine is preferable as the liquid crystal polyester.

Here, the aromatic hydroxycarboxylic acid, the aromatic dicarboxylic acid, the aromatic diol, the aromatic hydroxyamine, and the aromatic diamine may each independently be partially or completely substituted with a polymerizable ester-forming derivative thereof.

Examples of a polymerizable derivative of a compound having a carboxy group such as an aromatic hydroxycarboxylic acid and an aromatic dicarboxylic acid include an ester, an acid halide, and an acid anhydride. Examples of the above ester include a compound obtained by converting the carboxy group into an alkoxycarbonyl group or an aryloxycarbonyl group. Examples of the above acid halide include a compound obtained by converting the carboxy group into a haloformyl group. Examples of the above acid anhydride include a compound obtained by converting the carboxy group into an acyloxycarbonyl group.

Examples of a polymerizable derivative of a compound having a hydroxy group such as an aromatic hydroxycarboxylic acid, an aromatic diol, and an aromatic hydroxyamine include a compound obtained by acylating the hydroxy group to convert the same into an acyloxy group (acylated product).

Examples of a polymerizable derivative of a compound having an amino group such as an aromatic hydroxyamine and an aromatic diamine include a compound obtained by acylating the amino group to convert the same into an acylamino group (acylated product).

Among the examples of the polymerizable derivatives given as examples, acylated products obtained by acylating an aromatic hydroxycarboxylic acid and an aromatic diol are preferable as a raw material monomer of the liquid crystal polyester.

The liquid crystal polyester according to the embodiment preferably has a structural unit represented by the following formula (1) (hereinafter, sometimes referred to as a “structural unit (1)”):

—O-Ar1-CO— (1)
wherein Ar1 represents a divalent aromatic hydrocarbon group, and
one or more hydrogen atoms in the group represented by Ar1 are each independently optionally replaced with a halogen atom, an alkyl group having 1 to 10 carbon atoms, or an aryl group having 6 to 20 carbon atoms.

The liquid crystal polyester according to the embodiment more preferably has a structural unit (1) and a structural unit represented by the following formula (2) (hereinafter, sometimes referred to as a “structural unit (2)”), and a structural unit represented by the following formula (3) (hereinafter, sometimes referred to as a “structural unit (3)”).

—O-Ar1-CO— (1)

—CO-Ar2-CO— (2)

—X-Ar3-Y— (3)
wherein Ar1 represents a phenylene group, a naphthylene group, or a biphenylylene group;
Ar2 and Ar3 each independently represent a phenylene group, a naphthylene group, a biphenylylene group, or a group represented by the following formula (4); X and Y each independently represent an oxygen atom or an imino group (—NH—); and
one or more hydrogen atoms in the group represented by Ar1, Ar2, or Ar3 are each independently optionally replaced with a halogen atom, an alkyl group having 1 to 10 carbon atoms, or an aryl group having 6 to 20 carbon atoms.

-Ar4-Z-Ar5- (4)
wherein Ar4 and Ar5 each independently represent a phenylene group or a naphthylene group; Z represents an oxygen atom, a sulfur atom, a carbonyl group, a sulfonyl group, or an alkylidene group having 1 to 10 carbon atoms; and
one or more hydrogen atoms in the group represented by Ar4 or Ar5 are each independently optionally replaced with a halogen atom, an alkyl group having 1 to 10 carbon atoms, or an aryl group having 6 to 20 carbon atoms.

In the structural unit (3), X and Y are each preferably an oxygen atom.

Examples of the halogen atom with which a hydrogen atom can be replaced include a fluorine atom, a chlorine atom, a bromine atom, and an iodine atom.

Examples of the alkyl group having 1 to 10 carbon atoms with which a hydrogen atom can be replaced include a methyl group, an ethyl group, a 1-propyl group, an isopropyl group, a 1-butyl group, an isobutyl group, a sec-butyl group, a tert-butyl group, a 1-hexyl group, a 2-ethylhexyl group, a 1-octyl group, and a 1-decyl group.

Examples of the aryl group having 6 to 20 carbon atoms with which a hydrogen atom can be replaced include a monocyclic aromatic group such as a phenyl group, an orthotolyl group, a metatolyl group, or a paratolyl group, and a condensed aromatic group such as a 1-naphthyl group or a 2-naphthyl group.

When one or more hydrogen atoms in the group represented by Ar1, Ar2, Ar3, Ar4, or Ar5 are replaced with the halogen atom, the alkyl group having 1 to 10 carbon atoms, or the aryl group having 6 to 20 carbon atoms, the number of groups replacing the hydrogen atoms for each group represented by Ar1, Ar2, Ar3, Ar4, or Ar5 is, independently in each group, preferably one or two and more preferably one.

Examples of the alkylidene group having 1 to 10 carbon atoms include a methylene group, an ethylidene group, an isopropylidene group, a 1-butylidene group, and a 2-ethylhexylidene group.

The liquid crystal polyester according to the embodiment preferably comprises a structural unit comprising a naphthalene structure. The liquid crystal polyester comprising a structural unit comprising a naphthalene structure tends to have excellent dielectric properties.

In a liquid crystal polyester having the above structural unit (1), the above structural unit (2), and the above structural unit (3) as a liquid crystal polyester having a structural unit comprising a divalent naphthalene structure, at least one of a plurality of groups represented by Ar1, Ar2, Ar3, Ar4, and Ar5 is preferably a naphthylene group.

The above liquid crystal polyester encompasses the following liquid crystal polyester.

Liquid crystal polyester having a structural unit represented by the following formula (1), a structural unit represented by the following formula (2), and a structural unit represented by the following formula (3).

—O-Ar1-CO— (1)

—CO-Ar2-CO— (2)

—O-Ar3-O— (3)
wherein Ar1 represents a 2,6-naphthylene group, a 1,4-phenylene group, or a 4,4′-biphenylylene group;
Ar2 and Ar3 each independently represent a 2,6-naphthylene group, a 2,7-naphthylene group, a 1,4-phenylene group, a 1,3-phenylene group, or a 4,4′-biphenylylene group; and
one or more hydrogen atoms in the group represented by Ar1, Ar2, or Ar3 are each independently optionally replaced with a halogen atom, an alkyl group having 1 to 10 carbon atoms, or an aryl group having 6 to 20 carbon atoms.

Examples of the liquid crystal polyester having the structural units represented by the above formulas (1) to (3) include one having a structural unit represented by the following formula (1), a structural unit represented by the following formula (2), and a structural unit represented by the following formula (3):

—O-Ar1-CO— (1)

—CO-Ar2-CO— (2)

—O-Ar3-O— (3)
wherein Ar1 represents a naphthylene group, Ar2 represents a naphthylene group or a phenylene group, and Ar3 represents a phenylene group.
hydrogen atoms in the group represented by Ar1, Ar2, or Ar3 are each independently optionally replaced with a halogen atom, an alkyl group having 1 to 10 carbon atoms, or an aryl group having 6 to 20 carbon atoms.

The content of the structural unit comprising a naphthalene structure in the liquid crystal polyester is preferably 40 mol % or more, preferably 50 mol % or more, more preferably 55 mol % or more, and even more preferably 60 mol % or more, based on 100 mol % in total of all the structural units in the liquid crystal polyester (the value of the sum of the amount of substance equivalent (mol) of each structural unit constituting the liquid crystal polyester determined by dividing the mass of the structural unit by the formula mass of the each structural unit. Because the content of the structural unit comprising a naphthalene structure is equal to or more than the above lower limit value, the relative permittivity of the liquid crystal polyester can be even more lowered.

The content of the structural unit comprising a naphthalene structure in the liquid crystal polyester is preferably 90 mol % or less, more preferably 85 mol % or less, and even more preferably 80 mol % or less, per 100 mol % in total of all the structural units in the liquid crystal polyester. Because the content of the structural unit comprising a naphthalene structure is equal to or less than the above upper limit value, the reaction stability at the time of producing the liquid crystal polyester can be ensured.

An example of the numerical range of a value of the content of the structural unit comprising a naphthalene structure may be 40 mol % or more and 90 mol % or less, 50 mol % or more and 85 mol % or less, 55 mol % or more and 85 mol % or less, or 60 mol % or more and 80 mol % or less.

In the liquid crystal polyester according to the embodiment, Ar1 is preferably a 2,6-naphthylene group. The liquid crystal polyester in which Ar1 is a 2,6-naphthylene group preferably has the above structural unit (1), the above structural unit (2), and the above structural unit (3).

The liquid crystal polyester according to the embodiment may contain the structural unit in which Ar1 is a 2,6-naphthylene group in the structural unit represented by the above formula (1) in an amount of 40 mol % or more, 40 mol % or more and 90 mol % or less, 50 mol % or more and 85 mol % or less, or 55 mol % or more and 85 mol % or less, based on the total amount of all the structural units in the liquid crystal polyester.

The structural unit (1) is a structural unit derived from an aromatic hydroxycarboxylic acid.

Examples of the aromatic hydroxycarboxylic acid include 4-hydroxy benzoic acid, metahydroxybenzoic acid, 2-hydroxy-6-naphthoic acid, 2-hydroxy-3-naphthoic acid, 1-hydroxy-5-naphthoic acid, 4-hydroxy-4′-carboxydiphenyl ether, or an aromatic hydroxycarboxylic acid obtained by partially replacing the hydrogen atoms in the aromatic ring of such an aromatic hydroxycarboxylic acid listed above with a substituent selected from the group consisting of an alkyl group, an aryl group, and a halogen atom. The aromatic hydroxycarboxylic acids may be used singly or in combinations of two or more in the production of the liquid crystal polyester.

As the structural unit (1), one in which Ar1 is a 1,4-phenylene group (for example, a structural unit derived from 4-hydroxybenzoic acid) and one in which Ar1 is a 2,6-naphthylene group (for example, a structural unit derived from 6-hydroxy-2-naphthoic acid) are preferable.

The structural unit (2) is a structural unit derived from an aromatic dicarboxylic acid.

Examples of the aromatic dicarboxylic acid include terephthalic acid, isophthalic acid, biphenyl-4,4′-dicarboxylic acid, 2,6-naphthalenedicarboxylic acid, diphenyl ether-4,4′-dicarboxylic acid, and diphenyl thioether-4,4′-dicarboxylic acid, and an aromatic dicarboxylic acid obtained by partially replacing the hydrogen atoms in the aromatic ring of such an aromatic dicarboxylic acid listed above with a substituent selected from the group consisting of an alkyl group, an aryl group, and a halogen atom.

The aromatic dicarboxylic acids may be used singly or in combinations of two or more in the production of the liquid crystal polyester.

As the structural unit (2), one in which Ar2 is a 1,4-phenylene group (for example, a structural unit derived from terephthalic acid), one in which Ar2 is a 1,3-phenylene group (for example, a structural unit derived from isophthalic acid), one in which Ar2 is a 2,6-naphthylene group (for example, a structural unit derived from 2,6-naphthalenedicarboxylic acid), and one in which Ar2 is a diphenyl ether-4,4′-diyl group (for example, a structural unit derived from diphenyl ether-4,4′-dicarboxylic acid) are preferable.

The structural unit (3) is a structural unit derived from an aromatic diol, an aromatic hydroxyamine, or an aromatic diamine.

Examples of the aromatic diol, the aromatic hydroxyamine, or the aromatic diamine include 4,4′-dihydroxybiphenyl, hydroquinone, methylhydroquinone, resorcin, 4,4′-dihydroxydiphenyl ketone, 4,4′-dihydroxydiphenyl ether, bis(4-hydroxyphenyl)methane, 1,2-bis(4-hydroxyphenyl)ethane, 4,4′-dihydroxydiphenylsulfone, 4,4′-dihydroxydiphenyl thioether, 2,6-dihydroxynaphthalene, 1,5-dihydroxynaphthalene, 4-aminophenol, 1,4-phenylenediamine, 4-amino-4′-hydroxybiphenyl, and 4,4′-diaminobiphenyl.

The aromatic diols, the aromatic hydroxyamines, or the aromatic diamines may be used singly or in combinations of two or more in the production of the liquid crystal polyester.

As the structural unit (3), one in which Ar3 is a 1,4-phenylene group (for example, a structural unit derived from hydroquinone, 4-aminophenol, or 1,4-phenylenediamine) and one in which Ar3 is a 4,4′-biphenylylene group (for example, a structural unit derived from 4,4′-dihydroxybiphenyl, 4-amino-4′-hydroxybiphenyl, or 4,4′-diaminobiphenyl) are preferable.

When the liquid crystal polyester film obtained from the liquid crystal polyester composition of the embodiment is required to have particularly good heat resistance, the number of these substituents is preferably small, and particularly it is preferable not to have a substituent such as an alkyl group.

Next, liquid crystal polyesters particularly suitable for application to the liquid crystal polyester composition of the embodiment will be given as examples below.

Specific examples of the preferable liquid crystal polyesters include copolymers consisting of structural units derived from the following combinations of monomers.
1) 4-Hydroxybenzoic acid/2-hydroxy-6-naphthoic acid copolymer
2) 4-Hydroxybenzoic acid/terephthalic acid/4,4′-dihydroxybiphenyl copolymer
3) 4-Hydroxybenzoic acid/terephthalic acid/isophthalic acid/4,4′-dihydroxybiphenyl copolymer
4) 4-Hydroxybenzoic acid/terephthalic acid/isophthalic acid/4,4′-dihydroxybiphenyl/hydroquinone copolymer
5) 4-Hydroxybenzoic acid/terephthalic acid/hydroquinone copolymer
6) 2-Hydroxy-6-naphthoic acid/terephthalic acid/hydroquinone copolymer
7) 2-Hydroxy-6-naphthoic acid/terephthalic acid/2,6-naphthalenedicarboxylic acid/hydroquinone copolymer
8) 4-Hydroxybenzoic acid/2-hydroxy-6-naphthoic acid/terephthalic acid copolymer
9) 4-Hydroxybenzoic acid/2-hydroxy-6-naphthoic acid/isophthalic acid copolymer
10) 4-Hydroxybenzoic acid/2-hydroxy-6-naphthoic acid/terephthalic acid/4,4′-dihydroxybiphenyl copolymer
11) 4-Hydroxybenzoic acid/2-hydroxy-6-naphthoic acid/terephthalic acid/2,6-naphthalenedicarboxylic acid/4,4′-dihydroxybiphenyl copolymer
12) 4-Hydroxybenzoic acid/2-hydroxy-6-naphthoic acid/terephthalic acid/4,4′-dihydroxybiphenyl/methylhydroquinone copolymer
13) 2-Hydroxy-6-naphthoic acid/terephthalic acid/4,4′-dihydroxybiphenyl copolymer
14) 2-Hydroxy-6-naphthoic acid/terephthalic acid/isophthalic acid/4,4′-dihydroxybiphenyl copolymer
15) 2-Hydroxy-6-naphthoic acid/terephthalic acid/2,6-naphthalenedicarboxylic acid/4,4′-dihydroxybiphenyl copolymer
16) 2-Hydroxy-6-naphthoic acid/terephthalic acid/isophthalic acid/2,6-naphthalenedicarboxylic acid/4,4′-dihydroxybiphenyl copolymer
17) 4-Hydroxybenzoic acid/2-hydroxy-6-naphthoic acid/terephthalic acid/hydroquinone copolymer
18) 4-hydroxybenzoic acid/2-hydroxy-6-naphthoic acid/terephthalic acid/3,3′-dimethyl-1,1′-biphenyl-4,4′-diol copolymer
19) 4-Hydroxybenzoic acid/2-hydroxy-6-naphthoic acid/terephthalic acid/hydroquinone/4,4′-dihydroxybiphenyl copolymer
20) 4-Hydroxybenzoic acid/2,6-naphthalenedicarboxylic acid/4,4′-dihydroxybiphenyl copolymer
21) 4-Hydroxybenzoic acid/terephthalic acid/2,6-naphthalenedicarboxylic acid/hydroquinone copolymer
22) 4-Hydroxybenzoic acid/2,6-naphthalenedicarboxylic acid/hydroquinone copolymer
23) 4-Hydroxybenzoic acid/2-hydroxy-6-naphthoic acid/2,6-naphthalenedicarboxylic acid/hydroquinone copolymer
24) 4-Hydroxybenzoic acid/terephthalic acid/2,6-naphthalenedicarboxylic acid/hydroquinone/4,4′-dihydroxybiphenyl copolymer
25) 4-Hydroxybenzoic acid/terephthalic acid/4-aminophenol copolymer
26) 2-Hydroxy-6-naphthoic acid/terephthalic acid/4-aminophenol copolymer
27) 4-Hydroxybenzoic acid/2-hydroxy-6-naphthoic acid/terephthalic acid/4-aminophenol copolymer
28) 4-Hydroxybenzoic acid/terephthalic acid/4,4′-dihydroxybiphenyl/4-aminophenol copolymer
29) 4-Hydroxybenzoic acid/terephthalic acid/ethylene glycol copolymer
30) 4-Hydroxybenzoic acid/terephthalic acid/4,4′-dihydroxybiphenyl/ethylene glycol copolymer
31) 4-Hydroxybenzoic acid/2-hydroxy-6-naphthoic acid/terephthalic acid/ethylene glycol copolymer
32) 4-Hydroxybenzoic acid/2-hydroxy-6-naphthoic acid/terephthalic acid/4,4′-dihydroxybiphenyl/ethylene glycol copolymer
33) 4-Hydroxybenzoic acid/terephthalic acid/2,6-naphthalenedicarboxylic acid/4,4′-dihydroxybiphenyl copolymer.

The content of the structural unit (1) of the liquid crystal polyester is preferably 30 mol % or more, more preferably 30 to 90 mol %, more preferably 30 to 85 mol %, even more preferably 40 to 75 mol %, especially preferably 50 to 70 mol %, and particularly preferably 55 to 70 mol %, based on the total amount of all the structural units constituting the liquid crystal polyester (the value of the sum of the amount of substance equivalent (mol) of each structural unit constituting the liquid crystal polyester determined by dividing the mass of the structural unit by the formula mass of the structural unit).

When the content of the structural unit (1) of the liquid crystal polyester is 30 mol % or more, the heat resistance and the hardness of a film obtained by using the liquid crystal polyester composition of the present embodiment are easily improved. In addition, when the content of the structural unit (1) is 80 mol % or less, the melt viscosity can be lowered. Therefore, the temperature required for molding the liquid crystal polyester is likely to be low.

The content of the structural unit (2) of the liquid crystal polyester is preferably 35 mol % or less, more preferably 10 to 35 mol %, even more preferably 15 to 35 mol %, and especially preferably 17.5 to 32.5 mol %, based on the total amount of all the structural units constituting the liquid crystal polyester.

The content of the structural unit (3) of the liquid crystal polyester is preferably 35 mol % or less, more preferably 10 to 35 mol %, even more preferably 15 to 35 mol %, and especially preferably 17.5 to 32.5 mol %, based on the total amount of all the structural units constituting the liquid crystal polyester.

In the liquid crystal polyester, the proportion of the content of the structural unit (2) to the content of the structural unit (3) is, when expressed as [content of structural unit (2)]/[content of structural unit (3)](mol/mol), preferably 0.9 or more and 1.1 or less, more preferably 0.95 or more and 1.05 or less, and even more preferably 0.98 or more and 1.02 or less.

In the liquid crystal polyester, the proportion of the content of the structural unit (3) to the content of the structural unit (1) is, when expressed as [content of structural unit (3)]/[content of structural unit (1)](mol/mol), preferably 0.2 or more and 1.0 or less, more preferably 0.25 or more and 0.85 or less, and even more preferably 0.3 or more and 0.75 or less.

The liquid crystal polyester may have only one kind of the structural units (1) to (3), each independently, or may have two or more kinds of them. In addition, the liquid crystal polyester may have one or more than two structural units other than the structural units (1) to (3), and the content thereof is preferably 10 mol % or less, and more preferably 5 mol % or less, based on the total amount of all the structural units of the liquid crystal polyester.

The sum of the content of the structural unit (1) of the liquid crystal polyester resin, the content of the structural unit (2) of the liquid crystal polyester, and the content of the structural unit (3) of the liquid crystal polyester does not exceed 100 mol %.

In the present embodiment, it is also possible to use a liquid crystal polyester mixture in which a plurality of liquid crystal polyesters are mixed.

Here, the liquid crystal polyester resin mixture is a mixture of liquid crystal polyester resins different from each other in flow starting temperature. In the liquid crystal polyester resin mixture, the liquid crystal polyester resin having the highest flow starting temperature is referred to as a first liquid crystal polyester resin, and the liquid crystal polyester resin having the lowest flow starting temperature is referred to as a second liquid crystal polyester resin. A liquid crystal polyester resin mixture consisting substantially of the first liquid crystal polyester and the second liquid crystal polyester is preferable.

In addition, in the liquid crystal polyester mixture, the content of the second liquid crystal polyester is preferably 10 to 150 parts by mass, more preferably 30 to 120 parts by mass, and even more preferably 50 to 100 parts by mass, based on 100 parts by mass of the first liquid crystal polyester.

The flow starting temperature of the liquid crystal polyester included in the liquid crystal polyester powder of the present embodiment, determined by the following method, is preferably 255° C. or less, more preferably less than 250° C., and even more preferably 245° C. or less. A liquid crystal polyester powder comprising a liquid crystal polyester exhibiting a flow starting temperature equal to or less then the above upper limit value has the excellent property that the viscosity of a composition comprising the liquid crystal polyester powder is hardly increased.

The flow starting temperature of the liquid crystal polyester included in the liquid crystal polyester powder of the present embodiment, determined by the following method, may be 220° C. or more, 225° C. or more, or 230° C. or more from the viewpoint of increasing mechanical strength of the resulting liquid crystal polyester film. In addition, by using a liquid crystal polyester having a flow starting temperature equal to or more than the above lower limit value, the resulting film have high heat resistance.

An example of the temperature range of the flow starting temperature of the liquid crystal polyester included in the liquid crystal polyester powder of the present embodiment may be 220° C. or more and 255° C. or less, 225° C. or more and less than 250° C., or 230° C. or more and 245° C. or less.

When the liquid crystal polyester powder of the embodiment comprises two or more liquid crystal polyester resins different in flow starting temperature from each other, the flow starting temperature of the liquid crystal polyester can be the flow starting temperature of a mixture of such two or more liquid crystal polyester resins.

The flow starting temperature is a temperature at which a melt viscosity of 4800 Pa·s (48000 poises) is shown when a liquid crystal polyester is extruded from a nozzle at a temperature increase rate of 4° C./min under a load of 9.8 MPa (100 kg/cm²), using a capillary type rheometer equipped with a die having an inner diameter of 1 mm and a length of 10 mm. The flow starting temperature serves as an index representing the molecular weight of the liquid crystal polyester, well known in the art (see “Liquid Crystal Polymer Synthesis/Molding/Application-”, edited by Naoyuki Koide, CMC Publishing Co., Ltd., Jun. 5, 1987, pages 95 to 105). For example, a flow characteristic evaluation apparatus “Flowtester CFT-500D” manufactured by Shimadzu Corporation can be used as an apparatus for measuring the flow starting temperature.

(Method for Producing Liquid Crystal Polyester)

Next, an example of a method for producing the liquid crystal polyester according to the present embodiment will be described.

The liquid crystal polyester of the present embodiment is preferably produced by the following acylation step and polymerization step.

The acylation step is a step of obtaining an acylated product by acylating a phenolic hydroxy group contained in a raw material monomer with a fatty acid anhydride (for example, acetic anhydride).

In the polymerization step, a liquid crystal polyester may be obtained by polymerizing an acyl group of the acylated product obtained in the acylation step and carboxy groups of acylated products of an aromatic dicarboxylic acid and an aromatic hydroxycarboxylic acid in such a way as to cause ester exchange.

The acylation step and the polymerization step may be carried out in the presence of a heterocyclic organic base compound represented by the following formula (5).

[Formula 1]

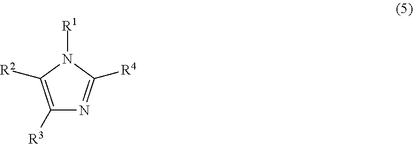

In the above formula (5), R¹ to R⁴ each independently represent a hydrogen atom, an alkyl group having 1 to 4 carbon atoms, a hydroxymethyl group, a cyano group, and a cyanoalkyl group having an alkyl group having 1 to 4 carbon atoms, a cyanoalkoxy group having an alkoxy group having 1 to 4 carbon atoms, a carboxy group, an amino group, an aminoalkyl group having 1 to 4 carbon atoms, an aminoalkoxy group having 1 to 4 carbon atoms, a phenyl group, a benzyl group, a phenylpropyl group, or a formyl group.

The heterocyclic organic base compound of the above formula (5) is preferably an imidazole derivative in which R¹ is an alkyl group having 1 to 4 carbon atoms and R² to R⁴ are each a hydrogen atom. Thereby, the reactivity of the acylation reaction in the acylation step and the ester exchange reaction in the polymerization step can be further improved. In addition, the color tone of the film obtained by using the liquid crystal polyester composition of the present embodiment can be further improved.

Among the heterocyclic organic base compounds, one or both of 1-methylimidazole and 1-ethylimidazole is particularly preferable because these are easily available.

In addition, the amount of the heterocyclic organic base compound used is preferably 0.005 to 1 part by mass when the total amount of the raw material monomers of the liquid crystal polyester (that is, an aromatic dicarboxylic acid, an aromatic diol, and an aromatic hydroxycarboxylic acid) is 100 parts by mass. In addition, from the viewpoint of the color tone and the productivity of the molded product, the amount of the heterocyclic organic base compound used is more preferably 0.05 to 0.5 parts by mass based on 100 parts by mass of the raw material monomers.

The heterocyclic organic basic compound may be present for a period of time during the acylation reaction and the ester exchange reaction, and the time of addition thereof may be immediately before the start of the acylation reaction or in the middle of the acylation reaction or between the acylation reaction and the ester exchange reaction. The liquid crystal polyester thus obtained has very high melt flowability and excellent thermal stability.

The amount of the fatty acid anhydride (for example, acetic anhydride) used should be determined in consideration of the amount of the aromatic diol and the aromatic hydroxycarboxylic acid used as raw material monomers. Specifically, based on the total equivalents of the phenolic hydroxy groups included in these raw material monomers, the amount of the fatty acid anhydride used is preferably 1.0 times equivalents or more and 1.2 times equivalents or less, more preferably 1.0 times equivalents or more and 1.15 times equivalents or less, even more preferably 1.03 times equivalents or more and 1.12 times equivalents or less, and particularly preferably 1.05 times equivalents or more and 1.1 times equivalents or less.

When the amount of the fatty acid anhydride used is 1.0 times equivalents or more based on the total equivalents of the phenolic hydroxy groups included in the raw material monomers, the acylation reaction is likely to proceed, and the unreacted raw material monomers are unlikely to remain in the subsequent polymerization step, and as a result, the polymerization proceeds efficiently. In addition, when the acylation reaction proceeds sufficiently as described above, there is little possibility that the unacylated raw material monomers sublimate and the fractionator used at the time of the polymerization is clogged. On the other hand, when the amount of the fatty acid anhydride used is 1.2 times equivalents or less, the liquid crystal polyester obtained is unlikely to be colored.

The acylation reaction in the above acylation step is preferably carried out in the temperature range between 130° C. and 180° C. for 30 minutes to 20 hours, and more preferably carried out between 140° C. and 160° C. for 1 to 5 hours.

The aromatic dicarboxylic acid used in the above polymerization step may be present in the reaction system during the acylation step. That is, in the acylation step, the aromatic diol, the aromatic hydroxycarboxylic acid, and the aromatic dicarboxylic acid may be present in the same reaction system. This is because neither the carboxy group nor the substituent optionally substituted in the aromatic dicarboxylic acid is affected by the fatty acid anhydride.

Therefore, a method of charging the aromatic diol, the aromatic hydroxycarboxylic acid, and the aromatic dicarboxylic acid into a reactor and then sequentially carrying out the acylation step and the polymerization step may be used, or a method of charging the aromatic diol and the aromatic dicarboxylic acid into a reactor to carry out the acylation step and then even more charging the aromatic dicarboxylic acid into the reactor to carry out the polymerization step may be used. The former method is preferable from the viewpoint of simplifying the production step.

The ester exchange reaction in the above polymerization step is preferably carried out while raising the temperature from 130° C. to 400° C. at a temperature increase rate between 0.1 and 50° C./min, and even more preferably carried out while raising the temperature from 150° C. to 350° C. at a temperature increase rate between 0.3 and 5° C./min.

In addition, when carrying out the ester exchange reaction in the polymerization step, in order to shift the equilibrium, a fatty acid (for example, acetic acid) generated as a by-product and the unreacted fatty acid anhydride (for example, acetic anhydride) are preferably evaporated and distilled out of the system. At this time, by refluxing a part of the distilled fatty acid back to the reactor, the raw material monomers or the like that evaporate or sublimate together with the fatty acid can also be condensed or reverse sublimated back to the reactor.

In the acylation reaction in the acylation step and the ester exchange reaction in the polymerization step, a batch apparatus may be used or a continuous apparatus may be used as the reactor. A liquid crystal polyester that can be used in the present embodiment can be obtained even by using any of the reaction apparatuses.

For example, a liquid crystal polyester having a desired flow starting temperature can be obtained by appropriately adjusting a reaction time taken for the above polymerization step.

A step for an increase in molecular weight of the liquid crystal polyester resin obtained in the polymerization step may be carried out after the above polymerization step. For example, an increase in molecular weight of the liquid crystal polyester resin can be achieved by cooling and then pulverizing the liquid crystal polyester resin obtained in the polymerization step to thereby produce a liquid crystal polyester resin in the form of a powder, and furthermore heating this powder.

Alternatively, an increase in molecular weight of the liquid crystal polyester resin can also be achieved by granulating the liquid crystal polyester resin in the form of a powder, obtained by cooling and pulverization, to thereby produce a liquid crystal polyester resin in the form of a pellet, and thereafter heating the liquid crystal polyester resin in the form of a pellet. An increase in molecular weight, using such a method, is referred to as solid phase polymerization in the art.

Solid phase polymerization is particularly effective as a method for an increase in molecular weight of the liquid crystal polyester resin. An increase in molecular weight of the liquid crystal polyester resin by solid phase polymerization enables a liquid crystal polyester resin satisfying the flow starting temperature of the liquid crystal polyester according to the embodiment to be easily obtained.

A method for heat-treating a resin in a solid state under an inert gas atmosphere or under reduced pressure for 1 to 20 hours is usually adopted for reaction conditions of the solid phase polymerization. The polymerization conditions of the solid phase polymerization can be appropriately optimized after the flow starting temperature of a resin obtained in the melt polymerization. Examples of the apparatus used in the heat-treatment include known drier, reactor, inert oven, and electric furnace.

The liquid crystal polyester satisfying the flow starting temperature described above can be easily obtained also by appropriately optimizing the structural units constituting the liquid crystal polyester. That is, if the linearity of the molecular chain of the liquid crystal polyester is improved, the flow starting temperature thereof tends to increase.

For example, the structural unit derived from terephthalic acid improves the linearity of the liquid crystal polyester molecular chain. On the other hand, the structural unit derived from isophthalic acid improves the flexibility (lowers the linearity) of the liquid crystal polyester molecular chain. Therefore, by controlling a copolymerization ratio of terephthalic acid and isophthalic acid, a liquid crystal polyester having a desired flow starting temperature can be obtained.

When the above liquid crystal polyester mixture is used, at least one liquid crystal polyester is preferably a polymer obtained by polymerizing raw material monomers comprising an aromatic hydroxycarboxylic acid in the presence of an imidazole compound. The liquid crystal polyester thus obtained has very high flowability at the time of melting and excellent thermal stability.

The number average molecular weight of the liquid crystal polyester in the liquid crystal polyester powder according to the embodiment is preferably 10000 or less, more preferably 3000 to 10000, even more preferably 4000 to 8000, and particularly preferably 5000 to 7000. When the number average molecular weight of the liquid crystal polyester in the liquid crystal polyester powder is 10000 or less, it is easy to process the same into a film having excellent isotropy. In addition, the smaller the number average molecular weight of the liquid crystal polyester is, the better the thermal conductivity in the thickness direction of the film after heat-treatment tends to be, which is preferable, and when the number average molecular weight of the liquid crystal polyester is equal to or greater than the above lower limit value, the heat resistance of the film after heat-treatment is improved, and the strength and the rigidity thereof are also improved.

In the present description, the “number average molecular weight” is an absolute value measured with a gel permeation chromatograph-multi-angle light scattering photometer.

(Characteristics)

In the liquid crystal polyester powder of the embodiment, a primary particle constituting the liquid crystal polyester powder may have a fibrillar form. At least one portion of the liquid crystal polyester powder may have a fibrillar form, or the entire primary particle may be in a fibrillar form. The “fibrillar” can be, for example, a fibril form having a fiber diameter (diameter) of preferably 0.1 μm or more and 10 μm or less and more preferably 0.5 μm or more and 5 μm or less and a value of fiber length/fiber diameter of preferably 2 or more.

The liquid crystal polyester powder having a fibrillar form can be identified by, for example, observing the liquid crystal polyester powder with a scanning electron microscope (SEM).

The fiber diameter and the fiber length of a fibril can be obtained by respectively measuring the diameters and the lengths of 100 fibrils randomly selected in a SEM image to determine the average values of 100 measurement values.

As the flow starting temperature of the liquid crystal polyester is higher, the liquid crystal polyester powder tends to have a fibrillar form having a smaller fiber diameter and a longer fiber length.

According to the liquid crystal polyester powder of the present embodiment, it is considered that, because the flow starting temperature of the liquid crystal polyester is equal to or more than the above predetermined value (for example, 220° C. or more), fibrillation of the liquid crystal polyester powder is made suitable, fibrils of the liquid crystal polyester powder properly tangle with each other, and mechanical strength of the resulting liquid crystal polyester film can be even more enhanced. In addition, because the flow starting temperature of the liquid crystal polyester is equal to or less than the above predetermined value (for example, 255° C. or less), probably, fibrillation of the liquid crystal polyester powder is suppressed and the viscosity of a composition can be hardly increased.

The liquid crystal polyester powder of the embodiment may comprise, for example, 50% or more and 100% or less, 60% or more and 95% or less, or 70% or more and 90% or less of a primary particle having a fibrillar form on a number basis, based on the primary particle contained in the liquid crystal polyester powder.

It is not necessary to dissolve the liquid crystal polyester powder in a medium in the method for producing a liquid crystal polyester film or a laminated body according to the embodiment described later, and thus the liquid crystal polyester powder having excellent dielectric properties can be adopted as a raw material. A liquid crystal polyester film having excellent dielectric properties can be produced from the liquid crystal polyester powder having excellent dielectric properties.

In the present description, the “dielectric properties” refer to properties relating to the relative permittivity and the dielectric loss tangent.

The liquid crystal polyester powder of the embodiment preferably has a relative permittivity at a frequency of 1 GHz of 3 or less, preferably 2.9 or less, preferably 2.8 or less, more preferably less than 2.8, even more preferably 2.78 or less, and particularly preferably 2.76 or less. In addition, the relative permittivity of the liquid crystal polyester powder may be 2.5 or more, 2.6 or more, or 2.7 or more. The above upper limit values and the above lower limit values of a value of the relative permittivity of the liquid crystal polyester powder can be freely combined. An example of the numerical range of a value of the relative permittivity of the liquid crystal polyester powder may be 2.5 or more and 3 or less, 2.6 or more and 2.78 or less, or 2.7 or more and 2.76 or less.

The liquid crystal polyester powder of the embodiment preferably has a dielectric loss tangent at a frequency of 1 GHz of 0.005 or less, preferably 0.004 or less, more preferably 0.003 or less, even more preferably 0.0025 or less, and particularly preferably 0.002 or less. In addition, the dielectric loss tangent of the liquid crystal polyester powder may be 0.0003 or more, 0.0005 or more, or 0.001 or more.

The above upper limit values and the above lower limit values of a value of the above dielectric loss tangent of the above liquid crystal polyester powder can be freely combined. An example of the numerical range of a value of the dielectric loss tangent of the liquid crystal polyester powder may be 0.0003 or more and 0.005 or less, 0.0005 or more and 0.004 or less, 0.001 or more and 0.003 or more, 0.001 or more and 0.0025 or less, and 0.001 or more and 0.002 or less.

The relative permittivity and the dielectric loss tangent at a frequency of 1 GHz of the liquid crystal polyester powder can be measured under the following conditions by a capacitance method using an impedance analyzer.

A liquid crystal polyester fine particle powder is melted at a temperature of 5° C. higher than the melting point measured using a flow tester, and then cooled and solidified to manufacture a tablet having a diameter of 1 cm and a thickness of 0.5 cm. The relative permittivity and the dielectric loss tangent at 1 GHz are measured under the following conditions for the obtained tablet.
Measurement method: Capacitance method
Electrode model: 16453A
Measurement environment: 23° C., 50% RH
Applied voltage: 1 V

The relative permittivity and the dielectric loss tangent of the liquid crystal polyester powder according to the embodiment may be different from those of the liquid crystal polyester film produced from the powder as a raw material. It is considered that the difference is because of the difference between the molecular weight of the liquid crystal polyester contained in the powder and that in the film.

The liquid crystal polyester powder is preferably insoluble in a medium and is more preferably insoluble in an aprotic solvent, contained in a liquid crystal polyester composition described later.

The liquid crystal polyester powder insoluble in the medium can be the liquid crystal polyester having the structural units represented by the above formulas (1) to (3), as an example.

Here, whether the liquid crystal polyester powder is insoluble in the medium can be confirmed by carrying out the following test. The following test method will be described about a case where the medium is an aprotic solvent.

Test Method

A liquid crystal polyester powder (5 parts by weight) is stirred in an aprotic solvent (medium) (95 parts by weight) at a temperature of 180° C. using an anchor blade under a stirring condition of 200 rpm for 6 hours, and then cooled to room temperature. Next, filtration is carried out using a membrane filter having an aperture size of 5 μm and a pressurized filtration machine, and then a residue on the membrane filter is checked. At this time, when no solid is found, it is determined that the powder is soluble in the aprotic solvent (medium). If a solid is found, it is determined that the powder is insoluble in the aprotic solvent (medium). The solid can be observed by microscopic observation.

(Method for Producing Liquid Crystal Polyester Powder)

The liquid crystal polyester powder of the embodiment can be obtained as the liquid crystal polyester powder where D₉₀ is 20 μm or less, by pulverizing a liquid crystal polyester resin comprising a liquid crystal polyester.

The above liquid crystal polyester resin can comprise a component constituting the liquid crystal polyester powder of the embodiment.

The liquid crystal polyester powder of the embodiment can be obtained by, for example, performing pulverization treatment using a jet mill or the like so that D₉₀ of the liquid crystal polyester powder may be 20 μm or less, as a method for pulverizing the liquid crystal polyester resin.

The particle diameter of the liquid crystal polyester powder can be controlled by changing the rotation speed of a classifying rotor, the pulverization nozzle pressure, the treatment speed, or the like, as a method for controlling the particle diameter of the liquid crystal polyester powder to be in the above range. In addition, the operation of particle classification may be carried out using a sieve having an aperture size corresponding to a desired particle diameter, after pulverization treatment.

<<Liquid Crystal Polyester Composition>>

The liquid crystal polyester composition of the embodiment comprises a medium and the liquid crystal polyester powder.

As the liquid crystal polyester powder, one described in the above <<Liquid crystal polyester powder>> can be given as an example.

<Medium>

The medium included in the liquid crystal polyester composition of the embodiment is preferably a substance that is in a liquid state at 1 atm (1013.25 hPa) and 25° C. The medium is preferably a volatile component that is a substance that can be volatilized during the producing of a liquid crystal polyester film.

The medium is preferably a dispersion medium in which a liquid crystal polyester powder is insoluble, and which disperses a liquid crystal polyester powder.

The liquid crystal polyester composition of the embodiment is preferably a dispersion wherein the liquid crystal polyester powder is insoluble in the medium and the liquid crystal polyester powder is dispersed in the medium that is a liquid.

The “dispersion” here refers to a state in which the liquid crystal polyester powder floats or is suspended in the dispersion medium, and is a term used to distinguish the above state from a state in which the liquid crystal polyester powder is dissolved (to except for a state in which the liquid crystal polyester powder is completely dissolved in the liquid crystal polyester composition). The distribution of the liquid crystal polyester powder in the composition may have a non-uniform part. The state of the liquid crystal polyester powder in the composition may be a state in which the liquid crystal polyester composition can be applied onto a support in the method for producing a liquid crystal polyester film described later.

Examples of the medium include an aliphatic polyhydric alcohol such as glycerin, neopentyl glycol, ethylene glycol, propylene glycol, butanediol, hexylene glycol, polyethylene glycol, or polypropylene glycol; a halogenated hydrocarbon such as dichloromethane, chloroform, 1,1-dichloroethane, 1,2-dichloroethane, 1,1,2,2-tetrachloroethane, 1-chlorobutane, chlorobenzene, or o-dichlorobenzene; a halogenated phenol such as p-chlorophenol, pentachlorophenol, or pentafluorophenol; an ether such as diethyl ether, di-(2-chloroethyl)ether, tetrahydrofuran, or 1,4-dioxane; a ketone such as acetone, cyclohexanone, or isophorone; an ester such as ethyl acetate, butyl lactate, and γ-butyrolactone; a carbonate such as ethylene carbonate or propylene carbonate; an amine such as triethylamine; a nitrogen-containing heterocyclic aromatic compound such as pyridine; a nitrile such as acetonitrile or succinonitrile; an amide such as N,N-dimethylformamide, N,N-dimethylacetamide, or N-methylpyrrolidone, a urea compound such as tetramethylurea; a nitro compound such as nitromethane or nitrobenzene; a sulfur compound such as dimethylsulfoxide or sulfolane; and a phosphorus compound such as hexamethylphosphoramide or tri n-butyl phosphate, and two or more of these may be used.

The medium may be an aprotic solvent. The aprotic solvent is a solvent comprising an aprotic compound. Examples of the aprotic solvent include a halogen-based solvent such as 1-chlorobutane, chlorobenzene, 1,1-dichloroethane, 1,2-dichloroethane, chloroform, or 1,1,2,2-tetrachloroethane, an ether-based solvent such as diethyl ether, tetrahydrofuran, or 1,4-dioxane, a ketone-based solvent such as acetone or cyclohexanone, an ester-based solvent such as ethyl acetate, a lactone-based solvent such as γ-butyrolactone, a carbonate-based solvent such as ethylene carbonate or propylene carbonate, an amine-based solvent such as triethylamine or pyridine, a nitrile-based solvent such as acetonitrile or succinonitrile, an amide-based solvent such as N,N-dimethylformamide, N,N-dimethylacetamide, tetramethylurea, or N-methylpyrrolidone, a nitro-based solvent such as nitromethane or nitrobenzene, a sulfide-based solvent such as dimethylsulfoxide or sulfolane, and a phosphoric acid-based solvent such as hexamethylphosphoramide or tri n-butyl phosphate.

The liquid crystal polyester composition of the embodiment may comprise a medium having a specific gravity of 0.90 or more as a medium having excellent dispersibility of the liquid crystal polyester powder.

In the present description, the “specific gravity” of a medium is one determined as measured in accordance with JIS Z 8804 using water as a reference substance. The specific gravity here is defined as the density of a sample liquid divided by the density of water under a pressure of 101325 Pa (1 atm).

The liquid crystal polyester composition of the embodiment preferably comprises a medium having a specific gravity of 0.90 or more, preferably comprises a medium having a specific gravity of 0.95 or more, even more preferably comprises a medium having a specific gravity of 1.03 or more, especially preferably comprises a medium having a specific gravity of 1.1 or more, and particularly preferably comprises a medium having a specific gravity of 1.3 or more. When the specific gravity of the medium is equal to or greater than the above lower limit value, the dispersibility of the liquid crystal polyester powder is excellent.

The upper limit value of the specific gravity may be 1.84 or less as an example. The liquid crystal polyester composition of the embodiment may comprise a medium having a specific density of 1.84 or less, a medium having a specific gravity of 1.68 or less, a medium having a specific gravity of 1.58 or less, or a medium having a specific gravity of 1.48 or less.

When the specific gravity of the medium is equal to or less than the above upper limit value, the liquid crystal polyester powder is prevented from floating on the liquid surface of the medium and becoming difficult to disperse.

The above upper limit values and the above lower limit values of a value of the specific gravity of the medium can be freely combined. As an example of the numerical range of a value of the specific gravity of the above medium, the liquid crystal polyester composition of the embodiment may comprise a medium having a specific gravity of 0.90 or more and 1.84 or less, a medium having a specific gravity of 0.95 or more and 1.68 or less, a medium having a specific gravity of 1.03 or more and 1.58 or less, or a medium having a specific gravity of 1.1 or more and 1.48 or less.

The proportion of the content of the liquid crystal polyester powder is preferably 1 to 40% by mass, more preferably 5 to 30% by mass, and even more preferably 7 to 20% by mass based on the total mass of the liquid crystal polyester composition of the embodiment.

The proportion of the content of the medium based on the total mass of the liquid crystal polyester composition of the embodiment is preferably 50 to 99% by mass, more preferably 60 to 95% by mass, and even more preferably 70 to 90% by mass.

An example of the liquid crystal polyester composition of the embodiment is
preferably a liquid crystal polyester composition where the proportion of the content of the liquid crystal polyester powder is 1 to 40% by mass and the proportion of the content of the medium is 50 to 99% by mass,
more preferably a liquid crystal polyester composition where the proportion of the content of the liquid crystal polyester powder is 5 to 30% by mass and the proportion of the content of the medium is 60 to 95% by mass, and
even more preferably a liquid crystal polyester composition where the proportion of the content of the liquid crystal polyester powder is 7 to 20% by mass and the proportion of the content of the medium is 70 to 90% by mass,
   based on the total mass (100% by mass) of the liquid crystal polyester composition.

Another example of the liquid crystal polyester composition of the embodiment is
preferably a liquid crystal polyester composition where the proportion of the content of the liquid crystal polyester powder is 1 to 40% by mass and the proportion of the content of the medium is 60 to 99% by mass,
more preferably a liquid crystal polyester composition where the proportion of the content of the liquid crystal polyester powder is 5 to 30% by mass and the proportion of the content of the medium is 70 to 95% by mass, and
even more preferably a liquid crystal polyester composition where the proportion of the content of the liquid crystal polyester powder is 7 to 20% by mass and the proportion of the content of the medium is 80 to 93% by mass,
   based on the total mass (100% by mass) of the liquid crystal polyester composition.

The proportion of the content of the solid is preferably 1 to 50% by mass, more preferably 5 to 40% by mass, and even more preferably 10 to 30% by mass based on the total mass of the liquid crystal polyester composition of the embodiment.

An example of the liquid crystal polyester composition of the embodiment is
preferably a liquid crystal polyester composition where the proportion of the content of the solid is 1 to 50% by mass and the proportion of the content of the medium is 50 to 99% by mass,
more preferably a liquid crystal polyester composition where the proportion of the content of the solid is 5 to 40% by mass and the proportion of the content of the medium is 60 to 95% by mass, and
even more preferably a liquid crystal polyester composition where the proportion of the content of the solid is 10 to 30% by mass and the proportion of the content of the medium is 70 to 90% by mass, based on the total mass (100% by mass) of the liquid crystal polyester composition.

The proportion of the content of the liquid crystal polyester powder may be 30 to 100% by mass, 40 to 90% by mass, or 50 to 80% by mass based on the total mass (100% by mass) of the solid contained in the liquid crystal polyester composition, as an example.

The “solids” included in the liquid crystal polyester composition of the embodiment refer to non-volatile components except for a substance that can be volatilized during the formation of the liquid crystal polyester film.

The proportion of the content of the liquid crystal polyester powder may be 50 to 100% by mass, 60 to 99% by mass, or 80 to 95% by mass based on the total mass (100% by mass) of a component insoluble in the medium included in the liquid crystal polyester composition.

The liquid crystal polyester composition may comprise, in addition to the medium and the liquid crystal polyester powder, if necessary, one or more other components such as a filler, an additive, and a resin that does not correspond to the liquid crystal polyester powder.

Examples of the filler include an inorganic filler such as silica, alumina, titanium oxide, barium titanate, strontium titanate, aluminum hydroxide, or calcium carbonate; and an organic filler such as cured epoxy resin, crosslinked benzoguanamine resin, or crosslinked acrylic resin, and the content thereof may be 0 based on 100 parts by mass of the liquid crystal polyester and is preferably 100 parts by mass or less.

Examples of the additive include a leveling agent, an antifoaming agent, an antioxidant, an ultraviolet absorbing agent, a flame retardant, and a colorant, and the content thereof may be 0 based on 100 parts by mass of the liquid crystal polyester and is preferably 5 parts by mass or less.

Examples of the resin other than the liquid crystal polyester include polypropylene, polyamide, a polyester other than the liquid crystal polyester, polyphenylene sulfide, polyether ketone, poly carbonate, polyether sulfone, polyphenylene ether and a modified product thereof, a thermoplastic resin other than the liquid crystal polyester such as polyetherimide; an elastomer such as a copolymer of glycidyl methacrylate and polyethylene; and a thermosetting resin such as a phenol resin, an epoxy resin, a polyimide resin, or a cyanate resin. A fluororesin can also be a preferable example of such other resin. The “fluororesin” means a resin containing a fluorine atom in its molecule, and examples thereof include a polymer having a structural unit containing a fluorine atom. The content of such other resin may be 0, and is preferably 20 parts by mass or less based on 100 parts by mass of the liquid crystal polyester powder. Such other resin is preferably soluble in the medium.

Such other resin described above may be a resin that does not correspond to the liquid crystal polyester powder, or may be a liquid crystal polyester. This liquid crystal polyester is preferably soluble in the medium and more preferably soluble in the aprotic solvent.

The liquid crystal polyester composition of the embodiment may comprise a medium, the liquid crystal polyester powder of the embodiment, insoluble in the medium, and a liquid crystal polyester soluble in the medium. In this case, the content of the liquid crystal polyester soluble in the medium may be 10 to 200 parts by mass, 20 to 150 parts by mass, or 30 to 100 parts by mass based on 100 parts by mass of the liquid crystal polyester powder insoluble in the medium in the liquid crystal polyester composition.

An example of the liquid crystal polyester composition of the embodiment is
preferably a liquid crystal polyester composition where the proportion of the content of the medium is 50 to 98% by mass, the proportion of the content of the liquid crystal polyester soluble in the medium is 1 to 40% by mass, and the proportion of the content of the liquid crystal polyester powder insoluble in the medium is 1 to 40% by mass,
more preferably a liquid crystal polyester composition liquid crystal where the proportion of the content of the medium is 60 to 90% by mass, the proportion of the content of the liquid crystal polyester soluble in the medium is 5 to 30% by mass, and the proportion of the content of the liquid crystal polyester powder insoluble in the medium is 5 to 30% by mass, and
even more preferably a liquid crystal polyester composition where the proportion of the content of the medium is 70 to 90% by mass, the proportion of the content of the liquid crystal polyester soluble in the medium is 5 to 15% by mass, and the proportion of the content of the liquid crystal polyester powder insoluble in the medium is 5 to 15% by mass,
   based on the total mass (100% by mass) of the liquid crystal polyester composition.

The medium in which the liquid crystal polyester soluble in the medium is dissolved is preferably in a liquid state in the liquid crystal polyester composition at 1 atm (1013.25 hPa) and 25° C.

In addition, whether the liquid crystal polyester is soluble in the medium can also be confirmed by carrying out the following test.

Test Method

A liquid crystal polyester powder (5 parts by mass) is stirred in a medium (95 parts by mass) at a temperature of 180° C. using an anchor blade under a stirring condition of 200 rpm for 6 hours, and then cooled to room temperature (23° C.). Next, filtration is carried out using a membrane filter having the aperture size of 5 μm and a pressurized filtration machine, and then a residue on the membrane filter is checked. At this time, when no solid is found, it is determined that the liquid crystalline polyester is soluble in the medium. When solid is found, it is determined that the liquid crystalline polyester is insoluble in the medium. The solid can be observed by microscopic observation.

Hereinafter, a liquid crystal polyester (X) soluble in the aprotic solvent will be described as an example of the liquid crystal polyester soluble in the medium.

The liquid crystal polyester (X) (hereinafter, also referred to as component (X)) preferably comprises structural units represented by the following formulas (X1), (X2), and (X3), as structural units.

As one aspect, the content of the structural unit represented by the formula (X1) is 30 to 80 mol %, the content of the structural unit represented by the formula (X2) is 35 to 10 mol %, and the content of the structural unit represented by the formula (X3) is 35 to 10 mol %, based on the total content of all the structural units constituting the component (X).

However, the total content of the structural unit represented by the formula (X1), the structural unit represented by the formula (X2), and the structural unit represented by the formula (X3) does not exceed 100 mol %.

—O—Ar1′-CO— (X1)

—CO—Ar2′-CO— (X2)

—X—Ar3′-Y— (X3)
wherein Ar1′ represents a 1,4-phenylene group, a 2,6-naphthylene group, or a 4,4′-biphenylene group; Ar2′ represents a 1,4-phenylene group, a 1,3-phenylene group, or a 2,6-naphthylene group; Ar3′ represents a 1,4-phenylene group or a 1,3-phenylene group; X is —NH—; and Y represents —O— or —NH—.

The structural unit (X1) is a structural unit derived from an aromatic hydroxycarboxylic acid, the structural unit (X2) is a structural unit derived from an aromatic dicarboxylic acid, and the structural unit (X3) is a structural unit derived from an aromatic diamine or an aromatic amine having a phenolic hydroxyl group. The component (X) may use an ester or amide-forming derivative of the above structural unit instead of the above structural unit.

In the present embodiment, preferably, the Ar1′ is a 2,6-naphthylene group, the Ar2′ is a 1,3-phenylene group, the Ar3′ is a 1,4-phenylene group, and the Y is —O—.

Examples of an ester-forming derivative of a carboxylic acid include one in which the carboxy group is converted into a derivative having high reaction activity such as an acid chloride or an acid anhydride that promotes a polyester-generating reaction, and one in which the carboxy group forms an ester with an alcohol, ethylene glycol, or the like that generates a polyester by an ester exchange reaction.

Examples of an ester-forming derivative of a phenolic hydroxyl group include one in which the phenolic hydroxyl group forms an ester with a carboxylic acid.

Examples of an amide-forming derivative of an amino group include one in which the amino group forms an amide with a carboxylic acid.

Examples of the structural units of the component (X) used in the present embodiment include, but are not limited to, the following.

Examples of the structural unit represented by the formula (X1) include a structural unit derived from 4-hydroxybenzoic acid, 6-hydroxy-2-naphthoic acid, or 4′-hydroxy-4-biphenylcarboxylic acid, and two or more of the structural units may be included in all the structural units. It is preferable to use a component (X) comprising the structural unit derived from 6-hydroxy-2-naphthoic acid among these structural units.

The content of the structural unit (X1) is 30 mol % or more and 80 mol % or less, preferably 40 mol % or more and 70 mol % or less, and more preferably 45 mol % or more and 65 mol % or less, based on the content of all the structural units constituting the component (X).

When the content of the structural unit (X1) is high, the solubility in a solvent tends to decrease remarkably, and when the content thereof is too low, the liquid crystallinity tends not to be exhibited. That is, when the content of the structural unit (X1) is within the above range, the solubility in a solvent is good and the liquid crystallinity is easily exhibited.

Examples of the structural unit represented by the formula (X2) include a structural unit derived from terephthalic acid, isophthalic acid, or 2,6-naphthalenedicarboxylic acid, and two or more of the structural units may be included in all the structural units. It is preferable to use a liquid crystal polyester comprising a structural unit derived from isophthalic acid among these structural units from the viewpoint of solubility in a solvent.

The content of the structural unit (X2) is preferably 10 mol % or more and 35 mol % or less, more preferably 15 mol % or more and 30 mol % or less, and particularly preferably 17.5 mol % or more and 27.5 mol % or less, based on the content of all the structural units constituting the component (X). When the content of the structural unit (X2) is too high, the liquid crystallinity tends to decrease, and when the content thereof is low, the solubility in a solvent tends to decrease. That is, when the content of the structural unit (X2) is within the above range, the liquid crystallinity is good and the solubility in a solvent is also good.

Examples of the structural unit represented by the formula (X3) include a structural unit derived from acetaminophen, 3-aminophenol, 4-aminophenol, 1,4-phenylenediamine, or 1,3-phenylenediamine, and two or more of the structural units may be included in all the structural units.

It is preferable to use a liquid crystal polyester comprising a structural unit derived from 4-aminophenol among these structural units from the viewpoint of reactivity.

The content of the structural unit (X3) is preferably 10 mol % or more and 35 mol % or less, more preferably 15 mol % or more and 30 mol % or less, and particularly preferably 17.5 mol % or more and 27.5 mol % or less, based on the content of all the structural units constituting the component (X). When the content of the structural unit (3) is too high, the liquid crystallinity tends to decrease, and when the content thereof is low, the solubility in a solvent tends to decrease. That is, when the content of the structural unit (X3) is within the above range, the liquid crystallinity is good and the solubility in a solvent is also good.

The structural unit (X3) is preferably used in substantially the same amount as the structural unit (X2), and by setting the content of the structural unit (X3) between 10 mol % lower and 10 mol % higher than the content of the structural unit (X2), the degree of polymerization of the liquid crystal polyester can also be controlled.

The liquid crystal polyester soluble in the medium can be produced by the same method as an example of the method for producing the liquid crystal polyester powder of the embodiment.

When the liquid crystal polyester (X) is made into the form of a powder, D₅₀ is preferably 100 to 2000 μm. D₅₀ of the liquid crystal polyester (X) in the form of a powder can be measured by a dry sieving method (for example, RPS-105 manufactured by Seishin Enterprise Co., Ltd.).

As one aspect, the content of the component (X) is preferably 5 to 10% by mass based on the total mass of the liquid crystal polyester composition.

According to the liquid crystal polyester composition comprising the liquid crystal polyester powder of the embodiment, because D₉₀ of the liquid crystal polyester powder is 20 μm or less, a liquid crystal polyester film having excellent mechanical strength can be produced at a high efficiency.

The liquid crystal polyester composition of the embodiment can be provided as a liquid crystal polyester composition for a film, which is used in the method for producing the liquid crystal polyester film of the embodiment.

In addition, according to the liquid crystal polyester composition of the embodiment, which is a dispersion in which the liquid crystal polyester powder is insoluble in the medium and the liquid crystal polyester powder is dispersed in the medium that is a liquid, it is possible to easily produce a liquid crystal polyester film having excellent dielectric properties.

While use of a liquid crystal polyester having increased solubility in a solvent has the advantage in a point of producing a film in which molecular orientation of the liquid crystal polyester is isotropic, the dielectric properties are sometimes lowered, for example, because the polarity is made higher.

On the other hand, the liquid crystal polyester composition of the embodiment comprises the liquid crystal polyester powder insoluble in the medium and thus the dielectric properties of a film can be easily enhanced.

<<Method for Producing Liquid Crystal Polyester Composition>>

The liquid crystal polyester composition of the embodiment can be obtained by mixing a medium, a liquid crystal polyester powder, and another component used as necessary in a batch or in an appropriate order.

As the medium and the liquid crystal polyester powder, those described in the above <<Liquid crystal polyester powder>> and <<Liquid crystal polyester composition>> can be given as examples.

One embodiment provides a method for producing the liquid crystal polyester composition, the method comprising mixing a medium and the liquid crystal polyester powder, wherein, when the particle diameter of the liquid crystal polyester powder, at which the cumulative volume proportion from the small particle side in a volume-based cumulative particle diameter distribution curve by laser diffraction/scattering type particle diameter distribution measurement is 90%, is defined as D₉₀, D₉₀ is 20 μm or less.

<<Method for Producing Liquid Crystal Polyester Film>>

The method for producing the liquid crystal polyester film of the embodiment is a method comprising obtaining a liquid crystal polyester film comprising a liquid crystal polyester by applying the liquid crystal polyester composition of the embodiment onto a support and heat-treating the liquid crystal polyester composition.

As the liquid crystal polyester composition, those described in the above <<Liquid crystal polyester composition>> can be given as examples.

The method for producing a liquid crystal polyester film may comprise the following steps.

A step of applying the liquid crystal polyester composition according to the embodiment onto a support to form a liquid crystal polyester film precursor on the support (application step).

A step of heat-treating the liquid crystal polyester film precursor to obtain a liquid crystal polyester film (heat-treatment step).

The application step in the method for producing a liquid crystal polyester film may comprise, after applying the liquid crystal polyester composition according to the embodiment onto a support, a step of removing the medium from the applied liquid crystal polyester composition (drying step).

That is, the method for producing a liquid crystal polyester film according to the embodiment may comprise obtaining a liquid crystal polyester film comprising a liquid crystal polyester by applying the liquid crystal polyester composition according to the embodiment onto a support, removing the medium from the applied liquid crystal polyester composition, and heat-treating the liquid crystal polyester composition.

In addition, the method for producing a liquid crystal polyester film may even more comprise a step of separating the support from a laminated body in which the support and the liquid crystal polyester film are laminated (separation step). The liquid crystal polyester film can be suitably used as a film for an electronic part even in a state of being formed on the support as a laminated body, and thus the separation step is not a necessary step in the production step of the liquid crystal polyester film.

Hereinafter, an example of the method for producing a liquid crystal polyester film according to the embodiment will be described with reference to drawings.

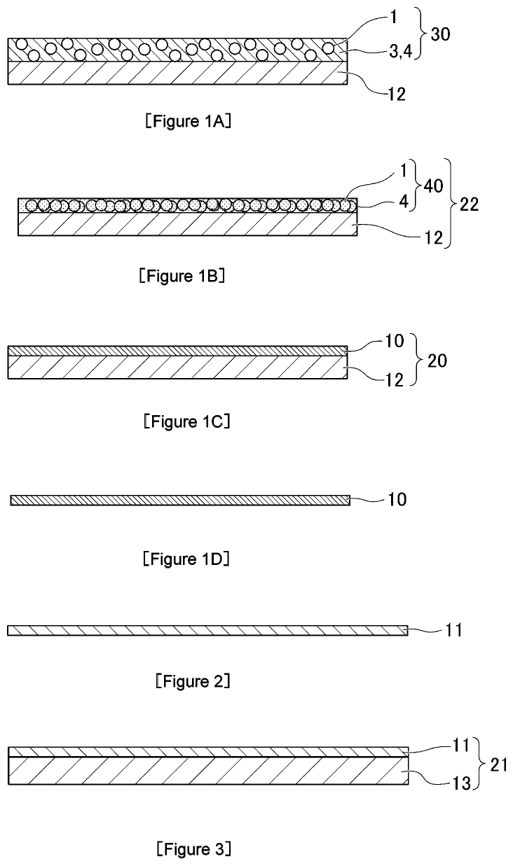

FIGS. 1A to 1D are schematic diagrams showing an example of a production process of the liquid crystal polyester film and the laminated body according to the embodiment.

First, a liquid crystal polyester composition 30 is applied onto a support 12 (application step in FIG. 1A). The liquid crystal polyester composition 30 comprises a liquid crystal polyester powder 1, a medium 3, and a resin 4 (not corresponding to the liquid crystal polyester powder) dissolved in the medium. A liquid crystal polyester composition can be applied onto the support by a roller coating method, a dip coating method, a spray coating method, a spinner coating method, a curtain coating method, a slot coating method, a screen printing method, or the like, and a method that enables application onto the support in such a way as to provide smoothness and uniformity on the surface can be appropriately selected. In addition, in order to make the distribution of the liquid crystal polyester powder uniform, the operation of stirring the liquid crystal polyester composition may be carried out before application.

The support 12 is preferably in the shape of a plate, a sheet, or a film, and examples thereof include a glass plate, a resin film, or a metal foil. Among these, a resin film or a metal foil is preferable, and a copper foil is particularly preferable because the copper foil has excellent heat resistance, it is easy to apply the liquid crystal polyester composition onto the copper foil, and it is easy to remove the copper foil from the liquid crystal polyester film.

Examples of the resin film include a polyimide (PI) film. Examples of a commercially available product thereof include “Upilex S” and “Upilex R” from UBE Corporation, “Kapton” from DuPont-Toray Co., Ltd., and “IF30,” “IF70,” and “LV300” from SKC Kolon PI, Inc. The thickness of the resin film is preferably 25 μm or more and 75 μm or less, and more preferably 50 μm or more and 75 μm or less. The thickness of the metal foil is preferably 3 μm or more and 75 μm or less, more preferably 5 μm or more and 30 μm or less, and even more preferably 10 μm or more and 25 μm or less.

Next, the medium 3 is removed from the liquid crystal polyester composition 30 applied onto the support 12 (FIG. 1B drying step) to obtain a liquid crystal polyester film precursor 40 to be heat-treated. The medium 3 does not have to be completely removed from the liquid crystal polyester composition, and a part of the medium included in the liquid crystal polyester composition may be removed, or the entire medium may be removed. In general, a component of the resin 4, dissolved in the medium, is not removed.

The proportion of the medium included in the liquid crystal polyester film precursor 40 is preferably 50% by mass or less, more preferably 3% by mass or more and 12% by mass or less, and even more preferably 5% by mass or more and 10% by mass or less, based on the total mass of the liquid crystal polyester film precursor. When the content of the medium in the liquid crystal polyester film precursor is equal to or greater than the above lower limit value, the possibility that the thermal conductivity of the liquid crystal polyester film decreases is reduced. In addition, when the content of the medium in the liquid crystal polyester film precursor is equal to or less than the above upper limit value, the possibility that the appearance of the liquid crystal polyester film is degraded by foaming or the like during the heat-treatment is reduced.

The medium is preferably removed by evaporating the medium, and examples of a method therefor include heating, depressurization, and ventilation, and these may be combined. In addition, the medium may be removed in a continuous manner or in a one-by-one manner. From the viewpoint of productivity and operability, the medium is preferably removed by heating in a continuous manner, and more preferably by heating while ventilating in a continuous manner. The temperature for medium removal is preferably a temperature lower than the melting point of the liquid crystal polyester powder, and is, for example, 40° C. or more and 200° C. or less, and preferably 60° C. or more and 200° C. or less. The time for medium removal is, for example, 0.2 hours or more and 12 hours or less, and preferably 0.5 hours or more and 8 hours or less.

A laminated body precursor 22 having the support 12 and the liquid crystal polyester film precursor 40 thus obtained is heat-treated to obtain a laminated body 20 having the support 12 and a liquid crystal polyester film 10 (a film obtained by heat-treating the liquid crystal polyester film precursor 40) (FIG. 1C heat-treatment step). At this time, the liquid crystal polyester film 10 formed on the support is obtained.

Because of the heat-treatment, the polymerization reaction (solid phase polymerization) of the liquid crystal polyester included in the liquid crystal polyester film precursor may more proceed.

Examples of a heat-treatment condition include raising the temperature from the temperature of 50° C. lower than the boiling point of the medium up to the heat-treatment temperature to be reached and then carrying out heat-treatment at a temperature equal to or higher than the melting point of the liquid crystal polyester.

During raising the temperature, the polymerization reaction of the liquid crystal polyester may proceed due to heating, but by increasing the temperature increase rate until the heat-treatment temperature is reached, the increase in the molecular weight of the liquid crystal polyester in the liquid crystal polyester powder can be suppressed to some extent, the liquid crystal polyester powder melts well, and a high-quality film can be easily obtained. The temperature increase rate from the temperature of 50° C. lower than the boiling point of the medium to the heat-treatment temperature is preferably 3° C./min or more, and more preferably 5° C./min or more.

The heat-treatment temperature is preferably equal to or higher than the melting point of the liquid crystal polyester, more preferably a temperature higher than the melting point of the liquid crystal polyester, and even more preferably a temperature of +5° C. or higher than the melting point of the liquid crystal polyester. The heat-treatment temperature may be appropriately determined depending on the type of the liquid crystal polyester, and as an example, the heat-treatment temperature is preferably 230° C. or more and 400° C. or less, more preferably 300° C. or more and 380° C. or less, and even more preferably 320° C. or more and 350° C. or less. By carrying out heat-treatment at a temperature higher than the melting point of the liquid crystal polyester, the liquid crystal polyester powder melts well, and a high-quality liquid crystal polyester film can be formed. It can be confirmed by the liquid crystal polyester film precursor 40 having become transparent that the liquid crystal polyester powder was able to be melted.

The boiling point of the medium here refers to the boiling point at the pressure during raising the temperature. In addition, when the heating of the laminated body precursor 22 is started from lower than the temperature of 50° C. lower than the boiling point of the medium, the temperature increase rate may be set in the range from the time of reaching the temperature of 50° C. lower than the boiling point of the medium to the time of reaching the heat-treatment temperature. The time taken to reach the temperature of 50° C. lower than the boiling point of the medium is arbitrary. In addition, the time after reaching the heat-treatment temperature may be regarded as the heat-treatment time. The heat-treatment time may be, for example, 0.5 hours or more, 1 hour or more and 24 hours or less, or 3 hours or more and 12 hours or less.

As an example of the heat-treatment, the heat-treatment temperature can be 230° C. or more and 400° C. or less and the heat-treatment time can be 0.5 hours or more.

As the removal of the medium, the heat-treatment may be carried out in a continuous manner or in a one-by-one manner, and from the viewpoint of productivity and operability, the heat-treatment is preferably carried out in a continuous manner, and more preferably carried out in a continuous manner following the removal of the medium.

Next, the liquid crystal polyester film 10 can be obtained as a single-layer film by separating the liquid crystal polyester film 10 from the laminated body 20 having the support 12 and the liquid crystal polyester film 10 (FIG. 1D separation step). When a glass plate is used as the support 12, the liquid crystal polyester film 10 is preferably separated from the laminated body 20 by peeling off the liquid crystal polyester film 10 from the laminated body 20. When a resin film is used as the support 12, the liquid crystal polyester film 10 is preferably separated from the laminated body 20 by peeling off the resin film or the liquid crystal polyester film 10 from the laminated body 20. When a metal foil is used as the support 12, the liquid crystal polyester film 10 is preferably separated from the laminated body 20 by etching and removing the metal foil. When a resin film, particularly a polyimide film, is used as the support, the polyimide film or the liquid crystal polyester film is easily peeled off from the laminated body 20, and a liquid crystal polyester film having a good appearance can be obtained. When a metal foil is used as the support, the laminated body 20 may be used as a metal-clad laminated plate for a printed wiring board without separating the liquid crystal polyester film from the laminated body 20.

According to the method for producing the liquid crystal polyester film of the embodiment, because D₉₀ of the liquid crystal polyester powder is 20 μm or less, a liquid crystal polyester film having excellent mechanical strength can be produced at a high efficiency.

In addition, the liquid crystal polyester powder used in the method for producing the film of the embodiment can be properly adjusted about the degree of fibrillation of the liquid crystal polyester powder by setting the flow starting temperature of the liquid crystal polyester to, for example, a value equal to or more than the above lower limit value (220° C. or more). Fibrils of the liquid crystal polyester powder properly tangle with each other, and this can also effectively increase the mechanical strength of the film produced.

According to the method for producing the liquid crystal polyester film of the embodiment, it is possible to easily obtain a liquid crystal polyester film in which the liquid crystal polyester powder may be insoluble in the medium and has excellent isotropy.

In addition, according to the method for producing the liquid crystal polyester film of the embodiment, it is possible to easily produce a liquid crystal polyester film having excellent dielectric properties by using the liquid crystal polyester composition of the embodiment, which is a dispersion in which the liquid crystal polyester powder is insoluble in the medium and the liquid crystal polyester powder is dispersed in the medium that is a liquid.

<<Method for Producing Laminated Body>>

The method for producing a laminated body according to the embodiment comprises obtaining a laminated body comprising a support and the liquid crystal polyester film by applying the liquid crystal polyester composition according to the embodiment onto the support and heat-treating the liquid crystal polyester composition to form a liquid crystal polyester film comprising a liquid crystal polyester.

The above method for producing a laminated body may comprise the following steps.

A step of applying the liquid crystal polyester composition according to the embodiment onto a support to form a liquid crystal polyester film precursor on the support (application step).

A step of heat-treating the liquid crystal polyester film precursor to obtain a laminated body comprising the support and the liquid crystal polyester film (heat-treatment step).

In the same way as the above method for producing a liquid crystal polyester film, the application step in the method for producing a laminated body may comprise, after applying the liquid crystal polyester composition according to the embodiment onto a support, a step of removing the medium from the applied liquid crystal polyester composition (drying step).

That is, the method for producing a laminated body according to the embodiment may comprise applying the liquid crystal polyester composition according to the embodiment onto a support, removing the medium from the applied liquid crystal polyester composition, and heat-treating the liquid crystal polyester composition to form a liquid crystal polyester film comprising a liquid crystal polyester to thereby obtain a laminated body comprising the support and the liquid crystal polyester film.

FIGS. 1A to 1D are schematic diagrams showing an example of a production process of the liquid crystal polyester film and the laminated body according to the embodiment. The method for producing a laminated body given as an example in FIGS. 1A to 1C is as described in the above <<Method for producing liquid crystal polyester film>> except that the above separation step (FIG. 1D) is not carried out, and thus the description thereof will be omitted.

According to the method for producing a laminated body according to the embodiment, a laminated body having the liquid crystal polyester film of the embodiment can be produced.

<Liquid Crystal Polyester Film>

FIG. 2 is a schematic diagram showing a configuration of a liquid crystal polyester film 11 according to the embodiment.

According to the liquid crystal polyester powder, a liquid crystal polyester film having good mechanical strength can be produced from a composition comprising the liquid crystal polyester powder. The values of tensile strength and tensile strength strain can be adopted as indexes of mechanical strength of the liquid crystal polyester film.

The value of tensile strength of the liquid crystal polyester film of the embodiment (hereinafter, sometimes simply referred to as the “film”), determined in accordance with JIS K7161, may be, for example, 120 MPa or more, 120 MPa or more and 200 MPa or less, or 130 MPa or more and 160 MPa or less.

The value of tensile strength strain of the liquid crystal polyester film of the embodiment, determined in accordance with JIS K7161, may be, for example, 10% or more, 11% or more and 20% or less, or 13% or more and 15% or less.

The values of tensile strength and tensile strength strain of the liquid crystal polyester film can be acquired by the following method.

The tensile strength and the tensile strength strain are measured with respect to a single-layer liquid crystal polyester film. For example, when copper foil is laminated on one surface of the liquid crystal polyester film, a single-layer liquid crystal polyester film is obtained by removing the copper foil by etching using a ferric chloride solution or the like. The single-layer liquid crystal polyester film is cut out to a dumbbell shape No. 3 test piece (width of parallel portion: 5 mm, length: 20 mm) based on JIS K6251, and a tensile test is carried out at a tensile rate of 5 mm/min using a tensile tester (for example, Autograph AG-IS manufactured by Shimadzu Corporation) in accordance with JIS K7161 and then the tensile strength (Pa) and the tensile strength strain (%) of the liquid crystal polyester film at 23° C. and a humidity of 50% RH are determined.

The relative permittivity at a frequency of 1 GHz of the film of the present embodiment may be 3 or less, and is preferably 2.9 or less, more preferably 2.8 or less, even more preferably 2.7 or less, and particularly preferably 2.6 or less. In addition, the relative permittivity of the film may be 2.3 or more, 2.4 or more, or 2.5 or more.

An example of the numerical range of a value of the relative permittivity of the film may be 2.3 or more and 3 or less, 2.4 or more and 2.9 or less, 2.5 or more and 2.8 or less, 2.5 or more and 2.7 or less, and 2.5 or more and 2.6 or less.

The film of the embodiment has a dielectric loss tangent at a frequency of 1 GHz of, preferably, 0.005 or less, preferably 0.004 or less, more preferably 0.003 or less, even more preferably 0.002 or less, and particularly preferably 0.001 or less. In addition, the dielectric loss tangent of the liquid crystal polyester film may be 0.0003 or more, 0.0005 or more, or 0.0007 or more.

An example of the numerical range of a value of the dielectric loss tangent of the film may be 0.0003 or more and 0.005 or less, 0.0005 or more and 0.004 or less, 0.0007 or more and 0.003 or less, 0.0007 or more and 0.002 or less, or 0.0007 or more and 0.001 or less.

The relative permittivity and the dielectric loss tangent at a frequency of 1 GHz of the film can be measured under the following conditions by a capacitance method using an impedance analyzer.

The film is melted at 350° C. using a flow tester and then cooled and solidified to manufacture a tablet having a diameter of 1 cm and a thickness of 0.5 cm. The relative permittivity and the dielectric loss tangent at 1 GHz of the obtained tablet are measured under the following conditions.
Measurement method: Capacitance method
Electrode model: 16453A
Measurement environment: 23° C., 50% RH
Applied voltage: 1 V

The liquid crystal polyester film of the embodiment comprises a liquid crystal polyester, has a relative permittivity at a frequency of 1 GHz of 3 or less, and has a dielectric loss tangent at a frequency of 1 GHz of 0.005 or less as an example.

The film of the embodiment has a value of the molecular orientation ratio (MOR) measured using a microwave orientation meter preferably in the range of 1 to 1.3, preferably in the range of 1 to 1.1, more preferably in the range of 1 to 1.08, even more preferably in the range of 1 to 1.06, and particularly preferably in the range of 1 to 1.04.

The molecular orientation ratio (MOR) is measured using a microwave molecular orientation meter (for example, MOA-5012A manufactured by Oji Scientific Instruments Co., Ltd.). The microwave molecular orientation meter is an apparatus that utilizes the fact that the transmission intensity of a microwave differs between the orientation direction and a perpendicular direction depending on the orientation of molecules. Specifically, a sample is irradiated with a microwave having a constant frequency (12 GHz is used) while rotating the sample, the intensity of the transmitted microwave that changes depending on the orientation of the molecules is measured, and the ratio of maximum value/minimum value thereof is defined as MOR. The interaction between a microwave electric field having a constant frequency and the dipoles that constitute the molecules relates to the inner product of the vectors of the both. Because of the anisotropy of the permittivity of the sample, the intensity of the microwave changes depending on the angle at which the sample is disposed, and this is why the orientation ratio is measured.

The film of the embodiment preferably has a linear expansion coefficient determined in the temperature range between 50° C. and 100° C. under a condition of a temperature increase rate of 5° C./min of 85 ppm/° C. or less, more preferably 50 ppm/° C. or less, even more preferably 40 ppm/° C. or less, and particularly preferably 30 ppm/° C. or less. The lower limit value of the linear expansion coefficient is not particularly limited, and is, for example, 0 ppm/° C. or more. In addition, the linear expansion coefficient of a copper foil is 18 ppm/° C., and thus for example, when the copper foil and the film are laminated, the linear expansion coefficient of the film of the embodiment is preferably a value close to that value. That is, the linear expansion coefficient of the film of the embodiment is preferably 0 ppm/° C. or more and 50 ppm/° C. or less, more preferably 10 ppm/° C. or more and 40 ppm/° C. or less, and even more preferably 20 ppm/° C. or more and 30 ppm/° C. or less. When the linear expansion coefficient differs depending on the direction or part of the film, the higher value is adopted as the linear expansion coefficient of the film. The linear expansion coefficient of the film can be measured using a thermomechanical analyzer (for example, model: TMA8310, manufactured by Rigaku Corporation). The film of the embodiment satisfying the above numerical range has a low linear expansion coefficient and high dimensional stability.

A film having excellent isotropy has a small difference in linear expansion coefficient depending on the measurement direction.

For the film of the embodiment, in the above linear expansion coefficient, the difference between the linear expansion coefficient in MD and the linear expansion coefficient in TD (MD−TD when MD >TD, and TD−MD when TD >MD) is preferably 2 ppm/° C. or less, and more preferably 1 ppm/° C. or less. In the film formed by the casting method, MD is the applying direction of the dispersion. As in the calculation of the above difference in the linear expansion coefficient, in reality, it is necessary to know the linear expansion coefficients in different directions, and thus, if MD and TD of the film are unknown, when any direction of the film is taken as MD and the direction that intersects at 90° therewith is taken as TD, the directions may be set so that the difference between the linear expansion coefficients in those directions may be the largest.

The film of the embodiment preferably has no hole or through hole as an appearance suitable for a film for an electronic part. When the film has a hole or a through hole, a plating liquid may seep into the hole or the through hole during plating. The liquid crystal polyester film produced from the liquid crystal polyester powder according to the embodiment as a raw material is of high quality, having a thickness suitable for a film for an electronic part and having the generation of a hole or a through hole suppressed.

The thickness of the film of the embodiment is not particularly limited, and the thickness suitable for a film for an electronic part is preferably 5 to 50 μm, more preferably 7 to 40 μm, even more preferably 10 to 33 μm, and particularly preferably 15 to 20 μm. In the present description, the “thickness” is the average value of values obtained by measuring the thickness at 10 randomly selected places in accordance with a JIS standard (K7130-1992).

A film having excellent dielectric properties can be obtained by selecting a raw material having excellent dielectric properties from any liquid crystal polyester. The proportion of the content of the liquid crystal polyester based on a total mass of the film of the embodiment of 100% by mass may be 50 to 100% by mass or 80 to 95% by mass.

A film satisfying the above requirements has suitable quality as a film for an electronic part. Examples of the standards of the quality include the above relative permittivity and dielectric loss tangent, and other factors such as molecular orientation ratio (isotropy of the film), tensile strength, tensile strength strain, thickness, and appearance (presence or absence of the occurrence of a hole or a through hole) are taken into consideration.

The method for producing the film of the embodiment is not particularly limited, and the film of the embodiment can be produced by the above <<Method for producing crystal polyester film>>.

As an example, the values of the relative permittivity and the dielectric loss tangent of the film can be controlled by the type of the liquid crystal polyester. In addition, as an example, the degree of isotropy of the film can be controlled by the method for producing the film.

The film of the embodiment can be suitably used for a use of a film for an electronic part such as a printed wiring board. The film of the embodiment can be provided as a substrate (for example, a flexible substrate), a laminated plate (for example, a flexible copper-clad laminated plate), a printed board, a printed wiring board, a printed circuit board, or the like, which comprise the film as an insulating material.

<Laminated Body>

The laminated body of the embodiment comprises a metal layer and the film according to the embodiment laminated on the metal layer.

FIG. 3 is a schematic diagram showing a configuration of a laminated body 21 according to one embodiment of the present invention. The laminated body 21 comprises a metal layer 13 and a film 11 laminated on the metal layer 13.

Examples of the film included in the laminated body include those given above as examples, and the description thereof will be omitted.

Examples of the metal layer included in the laminated body include those given as examples of the support in the above <<Method for producing liquid crystal polyester film>> and <<Method for producing laminated body>>, and a metal foil is preferable. Copper is preferable as a metal constituting the metal layer from the viewpoint of electric conductivity and cost, and a copper foil is preferable as the metal foil.

The thickness of the laminated body of the embodiment is not particularly limited, and is preferably 5 to 130 μm, more preferably 10 to 70 μm, and even more preferably 15 to 60 μm.

The method for producing the laminated body of the embodiment is not particularly limited, and the laminated body of the embodiment can be produced by the above <<Method for producing laminated body.

The laminated body of the embodiment can be suitably used for a use of a film for an electronic part such as a printed wiring board.

### EXAMPLES

Next, the present invention will be described in more detail with reference to Examples, but the present invention is not limited to the following Examples.

[Measurement of Flow Starting Temperature of Liquid Crystal Polyester]

Using a flow tester (“model CFT-500” manufactured by Shimadzu Corporation), a cylinder equipped with a die having a nozzle having an inner diameter of 1 mm and a length of 10 mm was filled with about 2 g of a liquid crystal polyester, the liquid crystal polyester was melted and extruded from a nozzle while raising the temperature at a rate of 4° C./min under a load of 9.8 MPa (100 kg/cm²), and the temperature (FT) showing a viscosity of 4800 Pa·s (48000P) was measured.

[Measurement of Particle Diameter of Liquid Crystal Polyester Powder]

Zero point zero one grams of a liquid crystal polyester powder was weighed and dispersed in about 10 g of pure water. The adjusted dispersion of the liquid crystal polyester powder was dispersed using an ultrasonic wave for 5 minutes. A volume-based cumulative particle diameter distribution of the liquid crystal polyester powder was measured as the refractive index of pure water being 1.333 using a laser diffraction/scattering type particle diameter distribution measuring apparatus (“LA-950V2” manufactured by HORIBA, Ltd.). The particle diameter (μm) at which the cumulative volume proportion from the small particle side was 90% was calculated as D₉₀.

In addition, the proportion (% by volume) of a particle having a particle diameter of 30 μm or more and the proportion of particles having a particle diameter (% by volume) of particle diameter 20 μm or more was calculated from the obtained cumulative particle diameter distribution, based on the total volume of the liquid crystal polyester powder subjected to measurement.

[Measurement of Tensile Strength of Liquid Crystal Polyester Film]

A single-layer liquid crystal polyester film was obtained by removing copper foil of a liquid crystal polyester film with a one-sided copper-clad plate, by etching using a ferric chloride solution. The obtained liquid crystal polyester film was cut out to a dumbbell No. 3 test piece (width of parallel portion: 5 mm, length: 20 mm) based on JIS K6251, and a tensile test was carried out at a tensile rate of 5 mm/min using a tensile tester (Autograph AG-IS manufactured by Shimadzu Corporation) in accordance with JIS K7161 and then the tensile strength (Pa) and the tensile strength strain (%) of the liquid crystal polyester film at 23° C. and a humidity of 50% RH were determined.

[Production of Liquid Crystal Polyester (A)]

Into a reactor equipped with a stirrer, a torque meter, a nitrogen gas introduction tube, a thermometer, and a reflux cooler were added 940.9 g (5.0 mol) of 6-hydroxy-2-naphthoic acid, 377.9 g (2.5 mol) of acetaminophen, 415.3 g (2.5 mol) of isophthalic acid and 867.8 g (8.4 mol) of acetic anhydride. The gas in the reactor was replaced with nitrogen gas, and then while stirring in a nitrogen gas stream, the temperature was raised from room temperature to 140° C. over 60 minutes and the resulting mixture was refluxed at 140° C. for 3 hours. Next, while distilling off by-produced acetic acid and unreacted acetic anhydride, the temperature was raised from 150° C. to 300° C. over 5 hours and held at 300° C. for 30 minutes, and then the contents were taken out from the reactor and cooled to room temperature. The obtained solid was pulverized using a pulverizer, and then a liquid crystal polyester (A1) in the form of a powder was obtained. The flow starting temperature of this liquid crystal polyester (A1) was 193.3° C.

A liquid crystal polyester (A2) in the form of a powder was obtained by, in a nitrogen atmosphere, raising the temperature of the liquid crystal polyester (A1) from room temperature to 160° C. over 2 hours and 20 minutes, next raising the temperature from 160° C. to 180° C. over 3 hours and 20 minutes, and holding the temperature at 180° C. for 5 hours to thereby cause solid phase polymerization, then cooling the resulting product, and next pulverizing the same using a pulverizer. The flow starting temperature of this liquid crystal polyester (A2) was 220° C.

A liquid crystal polyester (A) in the form of a powder was obtained by, in a nitrogen atmosphere, raising the temperature of the liquid crystal polyester (A2) from room temperature to 180° C. over 1 hour and 25 minutes, next raising the temperature from 180° C. to 255° C. over 6 hours and 40 minutes, and holding the temperature at 255° C. for 5 hours to thereby cause solid phase polymerization, and then cooling the resulting product. The flow starting temperature of the liquid crystal polyester (A) was 302° C.

[Preparation of Liquid Crystal Polyester Solution]

A liquid crystal polyester solution was be prepared by adding 8 parts by mass of the liquid crystal polyester (A) to 92 parts by mass of N-methylpyrrolidone (boiling point (1 atm) of 204° C.) and stirring the resulting mixture at 140° C. for 4 hours in a nitrogen atmosphere. The liquid crystal polyester (A) was soluble in N-methylpyrrolidone. The viscosity of this liquid crystal polyester solution at 23° C. was 955 mPa-s.

[Production of Liquid Crystal Polyester (B1)]

Into a reactor equipped with a stirrer, a torque meter, a nitrogen gas introduction tube, a thermometer, and a reflux cooler were added 1034.99 g (5.5 mol) of 2-hydroxy-6-naphthoic acid, 378.33 g (1.75 mol) of 2,6-naphthalenedicarboxylic acid, 83.07 g (0.5 mol) of terephthalic acid, 272.52 g (2.475 mol, 0.225 mol excess based on the total molar amount of 2,6-naphthalenedicarboxylic acid and terephthalic acid) of hydroquinone, 1226.87 g (12 mol) of acetic anhydride, and 0.17 g of 1-methylimidazole as a catalyst. The gas in the reactor was replaced with nitrogen gas, then the temperature was raised from room temperature to 145° C. over 15 minutes while stirring in a nitrogen gas stream, and the resulting mixture was refluxed at 145° C. for 1 hour.

Next, while distilling off an acetic acid generated as by-product and unreacted acetic anhydride, the temperature was raised from 145° C. to 310° C. over 3 hours and 30 minutes, and held at 310° C. for 10 minutes, and then a liquid crystal polyester (B1) in the form of a solid was taken out and this liquid crystal polyester (B1) was cooled to room temperature. The flow starting temperature of this polyester (B1) was 251.6° C.

[Powder of Example 1: Production of Liquid Crystal Polyester Powder (B2)]

Using a jet mill (“KJ-200” from Kurimoto, Ltd.), with the classifying rotor rotation speed set to 10000 rpm, the pulverization nozzle pressure set to 0.71 MPa, and the treatment speed set to 1.1 kg/hour, the liquid crystal polyester (B1) was pulverized to obtain a liquid crystal polyester powder (B2) of Example 1. D₉₀ of this liquid crystal polyester powder (B2) was 8 μm, the proportion of particles having a particle diameter of 30 μm or more was 0% by volume, and the proportion of particles having a particle diameter of 20 μm or more was 0% by volume.

[Powder of Example 2: Production of Liquid Crystal Polyester Powder (B3)]

Using a jet mill (“KJ-200” from Kurimoto, Ltd.), with the classifying rotor rotation speed set to 10000 rpm, the pulverization nozzle pressure set to 0.73 MPa, and the treatment speed set to 1.8 kg/hour, the liquid crystal polyester (B1) was pulverized to obtain a liquid crystal polyester powder (B3) of Example 2. D₉₀ of this liquid crystal polyester powder (B3) was 13 μm, the proportion of particles having a particle diameter of 30 μm or more was 0% by volume, and the proportion of particles having a particle diameter of 20 μm or more was 1.7% by volume.

[Powder of Comparative Example 1: Production of Liquid Crystal Polyester Powder (B4)]

Using a jet mill (“KJ-200” from Kurimoto, Ltd.), with the classifying rotor rotation speed set to 10000 rpm, the pulverization nozzle pressure set to 0.74 MPa, and the treatment speed set to 2.7 kg/hour, the liquid crystal polyester (B1) was pulverized to obtain a liquid crystal polyester powder (B4) of Comparative Example 1. D₉₀ of this liquid crystal polyester powder was 24 μm, the proportion of particles having a particle diameter of 30 μm or more was 4.9% by volume, and the proportion of particles having a particle diameter of 20 μm or more was 15.6% by volume.

[Preparation of Dispersion]

Each dispersion (liquid crystal polyester composition) comprising each of the powders of Examples 1 to 2 and Comparative Example 1 was prepared using a stirring defoaming apparatus (HM-500 manufactured by Keyence Corporation) by adding a liquid crystal polyester solution comprising the liquid crystal polyester (A) and each one of the liquid crystal polyester powders (B2) to (B4) in order for NMP of the obtained liquid crystal polyester solution described above to be 85.2 parts by mass, for the liquid crystal polyester (A) to be 7.4 parts by mass, and for each of the liquid crystal polyester powders (B2) to (B4) of the above Examples and Comparative Examples to be 7.4 parts by mass.

[Production of Liquid Crystal Polyester Film]

Each of the above prepared dispersions was cast onto a roughened surface of copper foil (3EC-VLP manufactured by Mitsui Mining & Smelting Co., Ltd., 18 μm), using a film applicator with a micrometer (“SA204” manufactured by TQC Sheen B.V.) and an automatic application apparatus (“Type I” manufactured by Tester Sangyo Co., Ltd.), so that the thickness of a cast film was 280 μm. Thereafter, a solvent was partially removed from the cast film by drying at 40° C. and at ordinary pressure (1 atm) for 4 hours.

The above prepared film with the copper foil was further subjected to heat-treatment where the temperature was raised from room temperature to 310° C. over 4 hours and the temperature was held for 2 hours in a hot air oven in a nitrogen atmosphere. As a result, a film with the copper foil, heat-treated, was obtained. The copper foil of this film with the copper foil was removed by etching using a ferric chloride solution, to obtain a single-layer liquid crystal polyester film. The thickness of the liquid crystal polyester film (film of Example 1) using the powder of Example 1 was 23 μm, the thickness of the liquid crystal polyester film (film of Example 2) using the powder of Example 2 was 24 μm, and the thickness of the liquid crystal polyester film (film of Comparative Example 1) using the powder of Comparative Example 1 was 30 μm. These single-layer liquid crystal polyester films were subjected to measurement of the tensile strength and the tensile strength strain. The results are shown in Table 1.

TABLE 1

| | | | | Comparative |
|---|---|---|---|---|
| | | Example 1 | Example 2 | Example 1 |
| Powder | | Powder | Powder | Powder |
| | | (B2) | (B3) | (B4) |
| | D90 [μm] | 8 | 13 | 24 |
| | Proportion of particles of | 0 | 0 | 4.9 |
| | 30 μm or more [% by | | | |
| | volume] | | | |
| | Proportion of particles of | 0 | 1.7 | 15.6 |
| | 20 μm or more [% by | | | |
| | volume] | | | |
| Film | Tensile strength [MPa] | 149 | 127 | 113 |
| | Tensile strength | 13 | 11 | 8 |
| | strain [%] | | | |

As shown in the above results, the films of Examples 1 and 2 according to the present invention wherein D₉₀ of the liquid crystal polyester powder was 20 μm or less exhibited excellent film strength (tensile strength and tensile strength strain) as compared with the film of Comparative Example 1.

The smaller the value of D₉₀ of the liquid crystal polyester powder became, the better the film strength of the resulting liquid crystal polyester film became.

In addition, the film strength of the resulting liquid crystal polyester film was enhanced by a low proportion of particles having a particle diameter of 30 μm or more in the liquid crystal polyester powder.

Similarly, focusing on the proportion of particles having a particle diameter of 20 μm or more in the liquid crystal polyester powder, the lower the proportion became, the better the film strength of the resulting liquid crystal polyester film became.

Each configuration in each embodiment, a combination thereof, and the like are examples, and addition, omission, substitution of a configuration, and other modifications of a configuration are possible unless they depart from the object of the present invention. In addition, the present invention is not limited to each embodiment, but is limited only to the scope of the claims.

### REFERENCE SIGNS LIST

1 . . . liquid crystal polyester powder, 3 . . . medium, 4 . . . resin, 30 . . . liquid crystal polyester composition, 10, 11 . . . liquid crystal polyester film, 12 . . . support, 13 . . . metal layer, 20, 21 . . . laminated body, 22 . . . laminated body precursor, 40 . . . liquid crystal polyester film precursor

1. A liquid crystal polyester powder comprising a liquid crystal polyester, wherein
when a particle diameter at which a cumulative volume proportion from a small particle side in a volume-based cumulative particle diameter distribution curve by laser diffraction/scattering type particle diameter distribution measurement is 90% is defined as D₉₀,
D₉₀ is 20 μm or less.

2. The liquid crystal polyester powder according to claim 1, wherein a proportion of particles having a particle diameter of 30 μm or more, determined by laser diffraction/scattering type particle diameter distribution measurement, is 3% by volume or less based on a total volume of the liquid crystal polyester powder.

3. The liquid crystal polyester powder according to claim 1, wherein a proportion of particles having a particle diameter of 20 μm or more, determined by laser diffraction/scattering type particle diameter distribution measurement, is 7% by volume or less based on a total volume of the liquid crystal polyester powder.

4. The liquid crystal polyester powder according to claim 1, wherein the liquid crystal polyester has a structural unit comprising a naphthalene structure.

5. The liquid crystal polyester powder according to claim 4, wherein a content of the structural unit comprising a naphthalene structure in the liquid crystal polyester is 40 mol % or more based on 100 mol % of a total amount of all structural units in the liquid crystal polyester.

6. The liquid crystal polyester powder according to claim 1, wherein the liquid crystal polyester has a structural unit represented by the following formula (1), a structural unit represented by the following formula (2), and a structural unit represented by the following formula (3):
—O-Ar1-CO— (1)
—CO-Ar2-CO— (2)
—X-Ar3-Y— (3)
wherein Ar1 represents a phenylene group, a naphthylene group, or a biphenylylene group;
Ar2 and Ar3 each independently represent a phenylene group, a naphthylene group, a biphenylylene group, or a group represented by the following formula (4); X and Y each independently represent an oxygen atom or an imino group (—NH—); and
one or more hydrogen atoms in the group represented by Ar1, Ar2, or Ar3 are each independently optionally replaced with a halogen atom, an alkyl group having 1 to 10 carbon atoms, or an aryl group having 6 to 20 carbon atoms;
-Ar4-Z-Ar5- (4)
wherein Ar4 and Ar5 each independently represent a phenylene group or a naphthylene group; Z represents an oxygen atom, a sulfur atom, a carbonyl group, a sulfonyl group, or an alkylidene group having 1 to 10 carbon atoms; and
one or more hydrogen atoms in the group represented by Ar4 or Ar5 are each independently optionally replaced with a halogen atom, an alkyl group having 1 to 10 carbon atoms, or an aryl group having 6 to 20 carbon atoms.

7. A liquid crystal polyester composition comprising a medium and the liquid crystal polyester powder according to claim 1.

8. The liquid crystal polyester composition according to claim 7, wherein the liquid crystal polyester powder is insoluble in the medium.

9. The liquid crystal polyester composition according to claim 7, further comprising a resin soluble in the medium.

10. The liquid crystal polyester composition according to claim 9, wherein the resin soluble in the medium is a liquid crystal polyester soluble in the medium.

11. A method for producing a liquid crystal polyester composition comprising a medium and the liquid crystal polyester power according to claim 1, the method comprising mixing a medium and the liquid crystal polyester powder.

12. A method for producing a liquid crystal polyester film, comprising: obtaining a liquid crystal polyester film comprising the liquid crystal polyester by applying the liquid crystal polyester composition according to claim 7 onto a support and heat-treating the liquid crystal polyester composition.

13. A method for producing a laminated body, comprising: obtaining a laminated body comprising a support and a liquid crystal polyester film by applying the liquid crystal polyester composition according to claim 7 onto the support and heat-treating the liquid crystal polyester composition to form the liquid crystal polyester film comprising the liquid crystal polyester.
